(19) United States
(12) Patent Application Publication
(10) Pub. No.: US 2021/0340337 A1
(43) Pub. Date: Nov. 4, 2021

(54) LATEX STYRENE BUTADIENE POWDERS AND ASPHALT COMPOSITION COMPRISING SAID POWDER

(71) Applicant: BASF SE, Ludwigshafen am Rhein (DE)

(72) Inventors: Kostas S. AVRAMIDIS, Charlotte, NC (US); Torben GAEDT, Trostberg (DE); Martin WINKLBAUER, Trostberg (DE); Christian SCHMIDTKE, Trostberg (DE); Sophie PUTZIEN, Trostberg (DE); Susanne SCHNEIDER, Trostberg (DE)

(73) Assignees: BASF SE, Ludwigshafen am Rhein (DE); BASF SE, Ludwigshafen am Rhein (DE)

(21) Appl. No.: 17/281,085

(22) PCT Filed: Sep. 25, 2019
(86) PCT No.: PCT/US2019/052919

§ 371 Date: Mar. 29, 2021

Related U.S. Application Data
(60) Provisional application No. 62/737,392, filed on Sep. 27, 2018.

(51) Int. Cl. C08J 3/12; C08L 9/08; C08L 5/00; C08L 33/02; C08L 39/06; C08L 31/04; C08L 95/00

(52) U.S. Cl. CPC C08J 3/126; C08L 9/08; C08L 5/00; C08L 33/02; C08L 2207/53; C08L 31/04; C08L 95/00; C08L 2201/54; C08L 39/06

(57) ABSTRACT

Provided herein are dispersible copolymer powders and asphalt compositions comprising the same. The dispersible copolymer powders comprise a core polymer having a glass transition temperature (T_{g}) of 40° C. or less and a shell comprising a water soluble protective colloid polymer having a T_{g} of 50° C. or greater. The core polymer can be derived from a vinyl aromatic monomer, a 1,3-diene monomer, and optionally one or more ethylenically-unsaturated monomers. The protective colloid polymer can be selected from a polyvinyl alcohol, a polyvinyl pyrrolidone, a polysaccharide, other water soluble polymers, or a combination thereof. Methods of preparing a styrene-butadiene modified asphalt without significantly increasing the viscosity, comprising adding the dispersible copolymer powder to an asphalt composition, wherein the addition of the copolymer polymer increases the viscosity of the asphalt by 100% or less at 135° C. within 2 hours of mixing are also described herein.

### FIELD OF THE DISCLOSURE

The present disclosure relates to latex styrene butadiene powders and asphalt compositions comprising the same.

### BACKGROUND

Aqueous polymer dispersions have a wide range of industrial applications including, for example, polymer-modification of bitumen, asphalt, cement, mortar, paper, and paint. Polymer-modified bitumen (PmB) has many advantages compared to non-modified bitumen including improved durability due to increased toughness at high temperatures which leads to less rutting, increased flexibility at low temperatures which leads to less cracking, and improved water resistance. Polymer-modified bitumen also improves adhesion within an asphalt-matrix as well as to the underlying layers it is applied.

In general, aqueous polymer dispersions are provided as latex particles dispersed in an aqueous dispersing medium. The aqueous dispersing medium, however, allows certain disadvantages. For example, biological decomposition (fungal/microbial attack), ageing, frost damage, and aggregation may become problematic in an aqueous environment. Further, when aqueous polymer dispersions are used in polymer modified bitumen, unneeded water is necessarily evaporated from the bitumen composition which consumes energy. Additionally, the transportation of water in the form of the aqueous polymer dispersions to the place of use is expensive.

Water-dispersible polymer powders, which are obtainable by drying the corresponding polymer dispersions, are known and have been used particularly in the building sector. They improve the property spectrum of hydraulically setting systems, such as cement mortars, for example their abrasion resistance, their flexural strength in tension and their adhesion. Very high requirements have to be met if a dispersion powder is to be industrially useful—it must be free-flowing, it must not block when stored, that is its free-flowing nature must not be lost over time. If blocking of the powder occurs, it becomes practically impossible to handle. To develop its full effectiveness, the powder must have very good re-dispersibility in water, giving the original particles of the dispersion.

There is a need for compositions comprising and methods for preparing re-dispersible polymer powders. The compositions and methods described herein address these and other needs.

### SUMMARY OF THE DISCLOSURE

Disclosed herein are dispersible copolymer powders and asphalt compositions comprising the same. The dispersible copolymer powders comprise a core polymer having a glass transition temperature (T_{g}) of 40° C. or less (preferably 25° C. or less, more preferably from −90° C. to 25° C. or from −80° C. to 0° C.) and a shell comprising a water soluble protective colloid polymer having a T_{g} of 50° C. or greater.

The core polymer can be derived from a vinyl aromatic monomer, a 1,3-diene monomer, and optionally one or more ethylenically-unsaturated monomers selected from the group consisting of meth(acrylate) monomers, vinyl acetate monomers, vinyl ester monomers, acid monomers, and combinations thereof. In some embodiments, the core polymer can be a random polymer, such as a random styrene-butadiene copolymer. The weight ratio of styrene to butadiene can be from 5:95 to 80:20 or from 5:95 to 30:70. In some examples, the core polymer comprises from 0.5% to 25%, preferably from 0.5% to 10%, more preferably from 0.5% to 5% by weight of a carboxylic acid monomer. Suitable carboxylic acid monomers include itaconic acid, fumaric acid, acrylic acid, methacrylic acid, and combinations thereof.

The protective colloid polymer present in the shell of the dispersible copolymer powders can be selected from a polyvinyl alcohol, a polyvinyl pyrrolidone, a polysaccharide, other water soluble polymers, or a combination thereof. Specific examples of the protective colloids include polysaccharides such as maltodextrin, hydroxyethyl cellulose, or a combination thereof. The molecular weight of the protective colloid polymer can be 100,000 Da or less, preferably 50,000 Da or less, more preferably 10,000 Da or less. The protective colloid polymer can have a glass transition temperature of from 50° C. to 200° C., from 60° C. to 180° C., from 50° C. to 150° C., or from 60° C. to 100° C.

The core polymer and the protective colloid polymer can be present in a weight ratio of from 2:1 to 20:1, preferably from 5:1 to 15:1.

Methods of making the dispersible copolymer powder are also disclosed herein. The method can include polymerizing monomers including a vinyl aromatic monomer, a 1,3-diene monomer, and optionally one or more ethylenically-unsaturated monomers selected from the group consisting of meth(acrylate) monomers, vinyl acetate monomers, vinyl ester monomers, acid monomers, and combinations thereof to produce a core polymer, blending the core polymer with a water soluble protective colloid to form a blend, and removing water from the blend to form the water-dispersible copolymer powder. Water can be removed from the blend by spray drying the blend at a temperature of 50° C. of greater, preferably from 50° C. to 150° C., more preferably from 60° C. to 140° C. The method can further include coagulating particles of the core polymer prior to blending with the protective colloid polymer. The method can also include mixing the blend with an anticaking agent prior to, during, or after spray drying or combinations thereof.

Asphalt compositions comprising the dispersible copolymer powders are also disclosed. The asphalt composition can comprise asphalt and the dispersible copolymer powder. The dispersible copolymer powder can be present in an amount of from 0.05% to 99.9% such as from 0.05% to 50% by weight, based on the weight of the asphalt composition. The asphalt composition can exhibit a fresh SHRP high temperature of 70° C. or greater, preferably 76° C. or greater, and a RTFO SHRP high temperature of 76° C. or greater, for asphalt compositions comprising at least 3% by weight or greater of the dispersible copolymer powder. The Brookfield viscosity of the asphalt composition at 135° C. can be less than 2,000 cP, preferably less than 1,500 cP, more preferably less than 1,000 cp, for asphalt compositions comprising at least 3% by weight or greater of the dispersible copolymer powder. Methods of producing asphalt compositions comprising the dispersible copolymer powders are also disclosed. The method can include blending asphalt and the dispersible copolymer powder to produce the asphalt composition. The asphalt and the dispersible copolymer powder can be mixed at a temperature of 120° C. or greater, preferably from 120° C. to 220° C. Methods of preparing a styrene-butadiene modified asphalt without significantly increasing the viscosity, comprising adding the dispersible copolymer powder to an asphalt composition, wherein the addition of the copolymer polymer increases the viscosity of the asphalt by 100% or less at 135° C. within 2 hours of mixing are also described herein.

The details of one or more embodiments are set forth in the description below. Other features, objects, and advantages will be apparent from the description and from the claims.

### DETAILED DESCRIPTION

As used herein, “(meth)acryl . . . ” includes acryl . . . and methacryl . . . and also includes diacryl . . . , dimethacryl . . . and polyacryl . . . and polymethacryl . . . . For example, the term “(meth)acrylate monomer” includes acrylate and methacrylate monomers, diacrylate and dimethacrylate monomers, and other polyacrylate and polymethacrylate monomers.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed. As used in this disclosure and in the appended claims, the singular forms “a”, “an”, “the”, include plural referents unless the context clearly dictates otherwise. The disclosure of percentage ranges and other ranges herein includes the disclosure of the endpoints of the range and any integers provided in the range.

### Dispersible Copolymer Powders

Disclosed herein are dispersible copolymer powders and compositions comprising the dispersible copolymer powders. The dispersible copolymer powders include a core polymer and a shell comprising a protective colloid polymer. The shell comprising the protective colloid polymer at least partially surrounds the core polymer. Methods of making and using the dispersible copolymer powders are also disclosed.

Core Polymer

The core polymer can be derived from ethylenically unsaturated monomers including a vinyl aromatic monomer (e.g. styrene, α-methylstyrene, o-chlorostyrene, and vinyltoluenes) and a conjugated diene (e.g. 1,3-butadiene and isoprene). The core polymer can be further derived from one or more additional ethylenically-unsaturated monomers. Suitable additional ethylenically unsaturated monomers for use in forming the core polymer include 1,2-butadiene (i.e. butadiene); α,β-monoethylenically unsaturated mono- and dicarboxylic acids or anhydrides thereof (e.g. acrylic acid, methacrylic acid, crotonic acid, dimethacrylic acid, ethylacrylic acid, allylacetic acid, vinylacetic acid maleic acid, fumaric acid, itaconic acid, mesaconic acid, methylenemalonic acid, citraconic acid, maleic anhydride, itaconic anhydride, and methylmalonic anhydride); esters of α,β-monoethylenically unsaturated mono- and dicarboxylic acids having 3 to 6 carbon atoms with alkanols having 1 to 12 carbon atoms (e.g. esters of acrylic acid, methacrylic acid, maleic acid, fumaric acid, or itaconic acid, with C₁-C₁₂, C₁-C₈, or C₁-C₄ alkanols such as ethyl, n-butyl, isobutyl and 2-ethylhexyl acrylates and methacrylates, dimethyl maleate and n-butyl maleate); acrylamides and alkyl-substituted acrylamides (e.g. (meth)acrylamide, N-tert-butylacrylamide, and N-methyl(meth)acrylamide); (meth)acrylonitrile; vinyl and vinylidene halides (e.g. vinyl chloride and vinylidene chloride); vinyl esters of C₁-C₁₈ mono- or dicarboxylic acids (e.g. vinyl acetate, vinyl propionate, vinyl n-butyrate, vinyl laurate and vinyl stearate); C₁-C₄ hydroxyalkyl esters of C₃-C₆ mono- or dicarboxylic acids, especially of acrylic acid, methacrylic acid or maleic acid, or their derivatives alkoxylated with from 2 to 50 moles of ethylene oxide, propylene oxide, butylene oxide or mixtures thereof, or esters of these acids with C₁-C₁₈ alcohols alkoxylated with from 2 to 50 mole of ethylene oxide, propylene oxide, butylene oxide or mixtures thereof (e.g. hydroxyethyl (meth)acrylate, hydroxypropyl (meth)acrylate, and methylpolyglycol acrylate); and monomers containing glycidyl groups (e.g. glycidyl methacrylate). The term “(meth)acryl . . . ,” as used herein, includes “acryl . . . ,” “methacryl . . . ,” or mixtures thereof.

The core polymer can further include one or more of the following additional monomers, other vinyl aromatic compounds (e.g., α-methylstyrene, o-chlorostyrene, and vinyltoluene); anhydrides of α,β-monoethylenically unsaturated monocarboxylic and dicarboxylic acids (e.g., maleic anhydride, itaconic anhydride, and methylmalonic anhydride); other alkyl-substituted acrylamides (e.g., N-tert-butylacrylamide and N-methyl(meth)acrylamide); vinyl and vinylidene halides (e.g., vinyl chloride and vinylidene chloride); vinyl esters of C₁-C₁₈ monocarboxylic or dicarboxylic acids (e.g., vinyl acetate, vinyl propionate, vinyl N-butyrate, vinyl laurate, and vinyl stearate); linear 1-olefins, branched-chain 1-olefins or cyclic olefins (e.g., ethene, propene, butene, isobutene, pentene, cyclopentene, hexene, and cyclohexene); vinyl and allyl alkyl ethers having 1 to 40 carbon atoms in the alkyl radical, wherein the alkyl radical can possibly carry further substituents such as a hydroxyl group, an amino or dialkylamino group, or one or more alkoxylated groups (e.g., methyl vinyl ether, ethyl vinyl ether, propyl vinyl ether, isobutyl vinyl ether, 2-ethylhexyl vinyl ether, vinyl cyclohexyl ether, vinyl 4-hydroxybutyl ether, decyl vinyl ether, dodecyl vinyl ether, octadecyl vinyl ether, 2-(diethylamino)ethyl vinyl ether, 2-(di-N-butylamino)ethyl vinyl ether, methyldiglycol vinyl ether, and the corresponding allyl ethers); sulfo-functional monomers (e.g., allylsulfonic acid, methallylsulfonic acid, styrenesulfonate, vinylsulfonic acid, allyloxybenzenesulfonic acid, 2-acrylamido-2-methylpropanesulfonic acid, and their corresponding alkali metal or ammonium salts, sulfopropyl acrylate, and sulfopropyl methacrylate); vinylphosphonic acid, dimethyl vinylphosphonate, and other phosphorus monomers (e.g., phosphoethyl (meth)acrylate); alkylaminoalkyl (meth)acrylates or alkylaminoalkyl(meth)acrylamides or quaternization products thereof (e.g., 2-(N,N-dimethylamino)ethyl (meth)acrylate, 3⁻(N,N-dimethylamino)propyl (meth)acrylate, 2-(N,N,N-trimethylammonium)ethyl (meth)acrylate chloride, 2-dimethylaminoethyl(meth)acrylamide, 3-dimethylaminopropyl(meth)acrylamide, and 3-trimethylammoniumpropyl(meth)acrylamide chloride); allyl esters of C₁-C₃₀ monocarboxylic acids; N-vinyl compounds (e.g., N-vinylformamide, N-vinyl-N-methylformamide, N-vinylpyrrolidone, N-vinylimidazole, 1-vinyl-2-methylimidazole, 1-vinyl-2-methylimidazoline, N-vinylcaprolactam, vinylcarbazole, 2-vinylpyridine, and 4-vinylpyridine); monomers containing 1,3-diketo groups (e.g., acetoacetoxyethyl (meth)acrylate or diacetone acrylamide); monomers containing urea groups (e.g., ureidoethyl (meth)acrylate, acrylamidoglycolic acid, and methacrylamidoglycolate methyl ether); monoalkyl itaconates; monoalkyl maleates; hydrophobic branched ester monomers; monomers containing silyl groups (e.g., trimethoxysilylpropyl methacrylate), vinyl esters of branched mono-carboxylic acids having a total of 8 to 12 carbon atoms in the acid residue moiety and 10 to 14 total carbon atoms such as, vinyl 2-ethylhexanoate, vinyl neo-nonanoate, vinyl neo-decanoate, vinyl neo-undecanoate, vinyl neo-dodecanoate and mixtures thereof, and copolymerizable surfactant monomers (e.g., those sold under the trademark ADEKA REASOAP). In some embodiments, the one or more additional monomers include (meth)acrylonitrile, (meth)acrylamide, or a mixture thereof. In some embodiments, the core polymer can include the one or more additional monomers in an amount of greater than 0% to 20% by weight, based on the weight of the copolymer. For example, the core polymer can include the one or more additional monomers in an amount of 0.5% to 15%, 0.5% to 10%, 0.5% to 5%, 0.5% to 4%, 0.5% to 3%, 0.5% to 2%, or 0.5% to 1% by weight, based on the weight of the core polymer.

The core polymer can include one or more crosslinking monomers. Exemplary crosslinking monomers include N-alkylolamides of α,β-monoethylenically unsaturated carboxylic acids having 3 to 10 carbon atoms and esters thereof with alcohols having 1 to 4 carbon atoms (e.g., N-methylolacrylamide and N-methylolmethacrylamide); glycidyl (meth)acrylate; glyoxal based crosslinkers; monomers containing two vinyl radicals; monomers containing two vinylidene radicals; and monomers containing two alkenyl radicals. Other crosslinking monomers include, for instance, diesters of dihydric alcohols with α,β-monoethylenically unsaturated monocarboxylic acids, of which in turn acrylic acid and methacrylic acid can be employed. Examples of such monomers containing two non-conjugated ethylenically unsaturated double bonds can include alkylene glycol diacrylates and dimethacrylates, such as ethylene glycol diacrylate, 1,3-butylene glycol diacrylate, 1,4-butylene glycol diacrylate and propylene glycol diacrylate, divinylbenzene, vinyl methacrylate, vinyl acrylate, allyl methacrylate, allyl acrylate, diallyl maleate, diallyl fumarate, methylenebisacrylamide, and mixtures thereof. In some embodiments, the core polymer can include from 0.01% to 5% by weight of the crosslinking agent.

The core polymer can be a random copolymer or a block copolymer. In some examples, the core polymer can be a random copolymer.

In some embodiments, the core polymer can be derived from ethylenically-unsaturated monomers including vinyl aromatic monomers (e.g., styrene), ethylenically unsaturated aliphatic monomers (e.g., butadiene), (meth)acrylic acid monomers, (meth)acrylate monomers, vinyl ester monomers (e.g., vinyl acetate), and combinations thereof. In some examples, the core polymer can include a styrene-butadiene copolymer (i.e., a polymer derived from butadiene and styrene monomers), a carboxylated styrene-butadiene copolymer (i.e., a polymer derived from butadiene, styrene, and carboxylic acid monomers), a styrene-butadiene-styrene block copolymer, a vinyl aromatic-acrylic copolymer (i.e., a polymer derived from vinyl aromatic monomers such as styrene and one or more (meth)acrylate and/or (meth)acrylic acid monomers), a styrene-butadiene-acrylic copolymer (i.e., a polymer derived from butadiene, styrene, and one or more (meth)acrylate and/or (meth)acrylic acid monomers), a vinyl-acrylic copolymer (i.e., a polymer derived from one or more vinyl ester monomers and one or more (meth)acrylate and/or (meth)acrylic acid monomers), a vinyl chloride polymer (i.e., a polymer derived from one or more vinyl chloride monomers), a vinyl alkanoate polymer (i.e., a polymer derived from one or more vinyl alkanoate monomers, such as polyvinyl acetate or a copolymer derived from ethylene and vinyl acetate monomers), or a combination thereof.

The core copolymer present in the dispersible copolymer powders can be formed from a latex composition. The latex composition can be an aqueous latex dispersion. In specific embodiments, the core copolymer can be formed from a latex composition including styrene, butadiene, and optionally, one or more additional monomers. The styrene can be in an amount of 5% or greater by weight, based on the weight of the core polymer. For example, the styrene can be in an amount of 7% or greater, 10% or greater, 20% or greater, 30% or greater, 40% or greater, 50% or greater, 60% or greater, or 70% or greater by weight, based on the weight of the core polymer. In some embodiments, the styrene can be in an amount of 95% or less, 90% or less, 85% or less, 80% or less, 75% or less, 70% or less, 65% or less, 60% or less, 55% or less, 50% or less, 45% or less, 40% or less, 35% or less, 30% or less, or 25% or less, by weight, based on the weight of the core polymer. The butadiene can be in an amount of 5% or greater by weight of the core polymer. For example, the butadiene can be in an amount of 7% or greater, 10% or greater, 20% or greater, 30% or greater, 40% or greater, 50% or greater, 60% or greater, or 70% or greater by weight, based on the weight of the core polymer. In some embodiments, the butadiene can be in an amount of 95% or less, 90% or less, 85% or less, 80% or less, 75% or less, 70% or less, 65% or less, 60% or less, 55% or less, 50% or less, 45% or less, 40% or less, 35% or less, 30% or less, or 25% or less, by weight, based on the weight of the core polymer. In some embodiments, the weight ratio of styrene to butadiene monomers in the core polymer can be from 5:95 to 95:5, from 10:99 to 99:10, from 5:95 to 80:20, from 20:80 to 80:20, from 5:95 to 70:30, from 30:70 to 70:30, or from 40:60 to 60:40. For example, the weight ratio of styrene to butadiene can be 25:75 or greater, 30:70 or greater, 35:65 or greater, or 40:60 or greater. In some examples, the core polymer can be a random copolymer, such as a random styrene-butadiene copolymer.

The core polymer can include a carboxylic acid monomer. For example, the core polymer can include a carboxylated styrene-butadiene copolymer derived from styrene, butadiene, and a carboxylic acid monomer. In some embodiments, the core polymer can be derived from 0% or greater, 0.5% or greater, 1.0% or greater, 1.5% or greater, 2.5% or greater, 3.0% or greater, 3.5% or greater, 4.0% or greater, or 5.0% or greater, by weight of a carboxylic acid monomer. In some embodiments, the core polymer can be derived 25% or less, 20% or less, 15% or less, or 10% or less, by weight of a carboxylic acid monomer. In some embodiments, the core polymer can be derived from 0.5%-25%, from 0.5%-10%, from 1.0%-9%, or from 2.0%-8% by weight of a carboxylic acid monomer. Suitable carboxylic acid monomers include (meth)acrylic acid, itaconic acid, fumaric acid, crotonic acid or mixtures thereof. In some embodiments, the core copolymer can include itaconic acid in an amount of from 0.5%-25%, from 0.5%-10%, or from 2%-8% by weight of the core polymer. In some embodiments, the core polymer includes one or more of the other monomers provided above.

The core polymer can have a glass-transition temperature (T_{g}), as measured by differential scanning calorimetry (DSC) using the mid-point temperature as described, for example, in ASTM 3418/82, of from −90° C. to less than 50° C. In some embodiments, the core polymer has a measured T_{g} of −90° C. or greater (for example, −80° C. or greater, −70° C. or greater, −60° C. or greater, −50° C. or greater, −40° C. or greater, −30° C. or greater, −20° C. or greater, −10° C. or greater, 0° C. or greater, 10° C. or greater, 20° C. or greater, or 25° C. or greater). In some cases, the core polymer has a measured T_{g} of 40° C. or less (e.g., less than 40° C., 30° C. or less, 25° C. or less, 20° C. or less, 10° C. or less, 0° C. or less, −10° C. or less, −20° C. or less, −25° C. or less, −30° C. or less, −35° C. or less, −40° C. or less, −45° C. or less, or −50° C. or less). In certain embodiments, the core polymer has a measured T_{g} of from −90° C. to 40° C., from −90° C. to 30° C., from −90° C. to 25° C., −90° C. to 0° C., −90° C. to −10° C., from −80° C. to 25° C., from −80° C. to 10° C., from −80° C. to 0° C., from −80° C. to −10° C., from −60° C. to 25° C., from −60° C. to 0° C., or from −60° C. to less than 0° C.

The dispersible copolymer powder can, for example, comprise 25% or more by weight of the core polymer (e.g., 30% or more, 35% or more, 40% or more, 45% or more, 50% or more, 55% or more, 60% or more, 65% or more, 70% or more, 75% or more, 80% or more, 85% or more, 90% or more, or 95% or more), based on the total weight of the dispersible copolymer powder. In some examples, the dispersible copolymer powder can comprise 95% or less by weight of the core polymer (e.g., 90% or less, 85% or less, 80% or less, 75% or less, 70% or less, 65% or less, 60% or less, 55% or less, 50% or less, 45% or less, 40% or less, or 35% or less), based on the total weight of the dispersible copolymer powder. The amount of the core polymer in the dispersible copolymer powder can range from any of the minimum values described above to any of the maximum values described above. For example, the dispersible copolymer powder can comprise from 25% to 95% by weight of the core polymer (e.g., from 30% to 95%, from 40% to 95%, from 50% to 95%, from 60% to 95%, from 35% to 85%, from 45% to 85%, from 50% to 85%, from 60% to 85%, or from 55% to 80%), based on the total weight of the dispersible copolymer powder.

Shell

As described herein, the dispersible copolymer powder can include a shell at least partially surrounding the core polymer. The shell comprises a protective colloid polymer. The protective colloid polymer can be a hydrophilic polymer, preferably a water soluble polymer. In some embodiments, the protective colloid polymer can be soluble in water at room temperature in an amount of greater than about 40% by weight (e.g., 45% or more, 50% or more, 55% or more, 60% or more, 65% or more, 70% or more, 75% or more, 80% or more, 85% or more, 90% or more, or 95% or more). In some examples, the protective colloid can be completely soluble in water at room temperature. In some embodiments, the protective colloid can have a water solubility of greater than 1 g/100 g water at 20° C. For example, the solubility of the protective colloid in water, measured at 20° C., can be 2 g/100 g water or greater, 5 g/100 g water or greater, 10 g/100 g water or greater, 15 g/100 g water or greater, 20 g/100 g water or greater, or 25 g/100 g water or greater. The hydrophilicity of the protective colloids can be defined by the log of their octanol/water partition coefficient (log P). The higher the numerical value, the more hydrophobic is the monomer. The log P of a compound can be calculated using MedChem, version 3.54, a software package available from the Medicinal Chemistry Project, Pomona College, Claremont, Calif. In some embodiments, the protective colloid can have a log P of less than 1, less than 0.5, or less than 0.

The weight average molecular weight (M_{w}) of the protective colloid can be, for example, 500 Da or more (e.g., 1,000 Da or more, 1,500 Da or more, 2,000 Da or more, 2,500 Da or more, 3,000 Da or more, 3,500 Da or more, 4,000 Da or more, 4,500 Da or more, 5,000 Da or more, 6,000 Da or more, 7,000 Da or more, 8,000 Da or more, 9,000 Da or more, 10,000 Da or more, 11,000 Da or more, 12,000 Da or more, 13,000 Da or more, 14,000 Da or more, 15,000 Da or more, 20,000 Da or more, or 25,000 Da or more). In some examples, the weight average molecular weight (M_{w}) of the protective colloid can be 100,000 Da or less (e.g., 90,000 Da or less, 80,000 Da or less, 70,000 Da or less, 60,000 Da or less, 50,000 Da or less, 40,000 Da or less, 30,000 Da or less, 25,000 Da or less, 20,000 Da or less, 19,000 Da or less, 18,000 Da or less, 17,000 Da or less, 16,000 Da or less, 15,000 Da or less, 14,000 Da or less, 13,000 Da or less, 12,000 Da or less, 11,000 Da or less, 10,000 Da or less, 9,000 Da or less, 8,000 Da or less, 7,000 Da or less, 6,000 Da or less, or 5,000 Da or less). The weight average molecular weight (M_{w}) of the protective colloid can range from any of the minimum values described above to any of the maximum values described above. For example, the weight average molecular weight (Mw) of the carbohydrate derived compound can be from 500 Da to 100,000 Da (e.g., from 1,000 Da to 100,000 Da, from 1,500 Da to 50,000 Da, from 2,000 Da to 20,000 Da, from 2,000 Da to 15,000 Da, from 1,500 Da to 12,000 Da, from 2,000 Da to 12,000 Da, from 1,000 Da to 10,000 Da, from 500 Da to 10,000 Da). The weight average molecular weight (Mw) of the protective colloid can be determined by GPC (gel permeation chromatography).

The protective colloid polymer can have a glass-transition temperature (T_{g}), as measured by differential scanning calorimetry (DSC) using the mid-point temperature as described, for example, in ASTM 3418/82, of 50° C. or greater. In some embodiments, the protective colloid polymer has a measured T_{g} of greater than 50° C. (for example, 55° C. or greater, 60° C. or greater, 65° C. or greater, 70° C. or greater, 75° C. or greater, 80° C. or greater, 85° C. or greater, 90° C. or greater, 95° C. or greater, 100° C. or greater, 105° C. or greater, 110° C. or greater, 115° C. or greater, 120° C. or greater, 125° C. or greater, 135° C. or greater, or 150° C. or greater). In some cases, the protective colloid polymer has a measured T_{g} of 220° C. or less (e.g., 210° C. or less, 200° C. or less, 195° C. or less, 190° C. or less, 180° C. or less, 170° C. or less, 160° C. or less, 150° C. or less, 140° C. or less, 130° C. or less, 120° C. or less, 110° C. or less, or 100° C. or less). In certain embodiments, the protective colloid polymer has a measured T_{g} of from 50° C. to 220° C., from 50° C. to 200° C., from 50° C. to 150° C., from 60° C. to 100° C., from 60° C. to 195° C., from 60° C. to 190° C., from 70° C. to 195° C., from 80° C. to 195° C., or from 85° C. to 190° C.

Suitable protective colloids for use in the shell include water soluble polymers such as polyvinyl alcohol, polyvinyl pyrrolidone, polysaccharides including celluloses and starches, gelatins, proteins such as casein or caseinate, soy protein, lignin sulfonates, natural and synthetic gums including gum arabic, synthetic water soluble polymers (for example, acrylic polymers such as poly(meth)acrylic acid and copolymers of (meth)acrylates with carboxyl-functional comonomer units, poly(meth)acrylamide, polyvinylsulfonic acids), or a combination thereof.

In some embodiments, the protective colloid can include a polysaccharide. The polysaccharide can have, for example, a dextrose equivalent (DE) of 5 or more (e.g., 6 or more, 7 or more, 8 or more, 9 or more, 10 or more, 10.5 or more, 11 or more, 11.5 or more, 12 or more, 12.5 or more, 13 or more, 13.5 or more, 14 or more, 14.5 or more, 15 or more, 16 or more, 17 or more, 18 or more, 19 or more, 20 or more, 21 or more, 22 or more, 23 or more, 24 or more, 25 or more, 30 or more, or 35 or more). In some examples, the polysaccharide can have a DE of 50 or less (e.g., 45 or less, 40 or less, 35 or less, 30 or less, 25 or less, 24 or less, 23 or less, 22 or less, 21 or less, 20 or less, 19 or less, 18 or less, 17 or less, 16 or less, 15 or less, 14.5 or less, 14 or less, 13.5 or less, 13 or less, or 12.5 or less). The DE value of the polysaccharide can range from any of the minimum values described above to any of the maximum values described above. For example, the polysaccharide can have a DE of from 10 to 50 (e.g., from 15 to 50, from 10 to 40, from 10 to 35, from 12.5 to 25, or from 15 to 20). The DE value can be determined in accordance with the Lane and Eynon test method (International Standard ISO 5377:1981).

Suitable examples of polysaccharides that can be included in the protective colloid includes maltodextrin, starch (for example, amylose and amylopectin), hydrophilic cellulose and their carboxymethyl, methyl, hydroxyethyl and hydroxypropyl derivatives (for example, hydroxyethyl cellulose, hydroxypropylmethylcellulose, hydroxypropylcellulose, carboxymethylcellulose, methylcellulose), pullulan, dextrin, or a combination thereof. In some examples, the protective colloid consists of maltodextrin. The maltodextrin can have the DE's, molecular weights, and water solubilities described above. In some examples, the protective colloid includes maltodextrin having a molecular weight of 10,000 Da or less.

The dispersible copolymer powder can comprise 1% or more by weight of the protective colloid (e.g., 2% or more, 3% or more, 4% or more, 5% or more, 6% or more, 7% or more, 8% or more, 9% or more, 10% or more, 11% or more, 12% or more, 13% or more, 14% or more, 15% or more, or 20% or more), based on the total weight of the core polymer and protective colloid polymer. In some examples, the dispersible copolymer powder can comprise 40% or less by weight of the protective colloid (e.g., 35% or less, 30% or less, 25% or less, 20% or less, 15% or less, 10% or less, 9% or less, 8% or less, 7% or less, 6% or less, or 5% or less), based on the total weight of the core polymer and protective colloid polymer. The amount of the protective colloid in the dispersible copolymer powder can range from any of the minimum values described above to any of the maximum values described above. For example, the dispersible copolymer powder can comprise from 1% to 40% by weight of the protective colloid (e.g., from 2% to 40%, from 5% to 25%, from 5% to 20%, from 5% to 15%, from 10% to 30%, from 10% to 25%, or from 7% to 25%), based on the total weight of the core polymer and protective colloid polymer.

The weight ratio between the core polymer and the protective colloid polymer in the dispersible copolymer powder can be 1:1 or greater. For example, the weight ratio between the core polymer and the protective colloid polymer can be 2:1 or greater, 3:1 or greater, 4:1 or greater, 5:1 or greater, 6:1 or greater, 7:1 or greater, 8:1 or greater, 9:1 or greater, 10:1 or greater, 12:1 or greater, 15:1 or greater, or 20:1 or greater. In some embodiments, the weight ratio between the core polymer and the protective colloid polymer can be 20:1 or less, 18:1 or less, 15:1 or less, 12:1 or less, 10:1 or less, 8:1 or less, or 5:1 or less. The weight ratio between the core polymer and the protective colloid polymer can range from any of the minimum values described above to any of the maximum values described above. For example, the weight ratio between the core polymer and the protective colloid polymer can be from 1:1 to 20:1, from 2:1 to 15:1, from 5:1 to 20:1, or from 5:1 to 15:1.

In addition to the protective colloid, the shell of the dispersible copolymer powders can include one or more additives. The one or more additional in the shell can be selected from antifoam agents, anti-caking agents (also referred to herein as anti-blocking agents), surfactants, or mixtures thereof. Without wishing to be bound by theory, latex dispersion particles having low T_{g}s, such as a T_{g}<20° C. may agglomerate irreversible during the drying process and cannot be re-dispersed after spray drying. In some embodiments, the shell can include anti-caking agents. The anti-caking (anti-blocking) agent can increase the shelf life of the dispersible copolymer powders by improving resistance to blocking, in particular for powders with a low glass transition temperature. The anti-caking (anti-blocking) agent can be included in the shell in an amount of up to 30% by weight, based on the total weight of the shell components. The anti-caking agent can be of mineral origin. Examples of anti-caking (anti-blocking) agents include calcium carbonate, magnesium carbonate, talc, clays such as kaolin, gypsum, silica, silicates, and mixtures thereof. The anti-caking (anti-blocking) agents can have particle sizes from 10 nm to 50 microns such as from 10 nm to 10 microns.

The shell can include up to 1.5% by weight of antifoam agent, based on the shell components in the dispersible copolymer powders. The antifoam agent can be advantageous especially in the case of nozzle spraying. Additional additives such as pigments, fillers, foam stabilizers, and hydrophobizing agents may also be included in the shell.

The dispersible copolymer powders can further include an antioxidant to prevent oxidation of, for example, the double bonds of the styrene butadiene polymer. Suitable antioxidants can include substituted phenols or secondary aromatic amines. The powders can include antiozonants to prevent ozone present in the atmosphere from, for example, cracking the styrene butadiene polymer, by cleaving the double bonds of the styrene butadiene polymer. The powders can include prevulcanization inhibitors to prevent premature vulcanization or scorching of the polymer. Suitable antioxidants, antiozonants, and prevulcanization inhibitors are disclosed in U.S. Pat. No. 8,952,092 B2. The antioxidants, antiozonants, and/or prevulcanization inhibitors can be provided in an amount from 1% to 5% by weight, based on the weight of the dispersible copolymer powders. The antioxidants, antiozonants, and/or prevulcanization inhibitors can be present with the core polymer or in the shell of the dispersible copolymer powders.

Chelating agents have been used as a colloidal stabilizer for water insoluble redispersible polymer powders for preventing aggregation or flocculation of the water insoluble polymer particles and for promoting redispersibility in an aqueous media. In some embodiments, the dispersible copolymer powders described herein do not includes chelating agent such as alkylenepolyamine polyacetates, porphyrins, ethylenediamines and its derivatives, dimercaprol or 2,3-dimercapto-1-propanol, succinic acid, nitrilotriacetic acid (NTA), 2,3-dimercaptosuccinic acid (DMSA), sodium diethanolglycine, salts thereof, and mixtures thereof.

The dispersible copolymer powders comprising the core copolymer and shell disclosed herein can have a median particle size (D₅₀) of from 10 microns to 300 microns, such as from 10 microns to 200 microns, from 10 nm to 150 microns, or from 10 microns to 100 microns. The particle size of the dispersible copolymer powders can be measured with a Camsizer (Retsch GmbH), using a dispersing pressure of 50 kPa. The copolymer latex, prior to drying, can have a median particle size of from 50 nm to 1000 nm, such as from 50 nm to 500 nm, from 50 nm to 300 nm, or from 50 nm to 200 nm. The particle size of the copolymer latex particles can be measured using dynamic light scattering measurements, for example using a Nicomp Model 380 available from Particle Sizing Systems, Santa Barbara, Calif.

### Asphalt Compositions

Disclosed herein are also asphalt compositions. In some embodiments, the asphalt composition can include asphalt and a dispersible copolymer powder as described herein.

The term “asphalt” as used herein, includes the alternative term “bitumen.” Thus, the asphalt compositions can be termed bitumen compositions. “Asphalt composition” as used herein, include asphalt emulsions and hot-mix asphalt compositions. The asphalt can be molten asphalt. The asphalt compositions can include 50% or greater by weight of the asphalt compositions, of asphalt. In some embodiments, the asphalt compositions can include 55% or greater, 60% or greater, 65% or greater, 70% or greater, 75% or greater, 80% or greater, 85% or greater, 90% or greater, 95% or greater, or 99% or greater by weight of the asphalt compositions, of asphalt. In some embodiments, the asphalt compositions can include 99.9% or less, 99% or less, 95% or less, 90% or less, 87% or less, 85% or less, 83% or less, or 80% or less by weight of the asphalt compositions, of asphalt. In some embodiments, the asphalt compositions can include 50% to 99.9%, 50% to 95%, 50% to 90%, 50% to 85%, 50% to 80%, 60% to 95%, 60% to 90%, or 60% to 80% by weight of the asphalt compositions, of asphalt.

In some embodiments, the asphalt used in the compositions disclosed herein has a high temperature true performance grade of 45° C. or greater, such as 48° C. or greater, 50° C. or greater, 52° C. or greater, 54° C. or greater, 55° C. or greater, 56° C. or greater, or 58° C. or greater, as determined by AASHTO test TP5. In some embodiments, the asphalt used in the compositions disclosed herein has a low temperature true performance grade of −10° C. or less, −15° C. or less, −20° C. or less, −25° C. or less, −28° C. or less, such as −30° C. or less, −32° C. or less, −34° C. or less, −35° C. or less, −40° C. or less, as determined by AASHTO test TP5. The compositions disclosed herein are applicable to various types of asphalts, including asphalts softer than PG 64-22. Specifically, the compositions disclosed herein can be used with asphalts such as PG 58-28 asphalts or softer.

In some embodiments, the asphalt is provided as an asphalt emulsion. The asphalt emulsion can include asphalt and one or more surfactants (emulsifiers) such as nonionic surfactants, anionic surfactants, cationic surfactants, amphoteric surfactants, or a mixture thereof. In some embodiments, the asphalt emulsion can include an amine-derived surfactant. Suitable surfactants include polyamines, fatty amines, fatty amido-amines, ethoxylated amines, diamines, imidazolines, quaternary ammonium salts, and mixtures thereof. Examples of commercially available surfactants that can be used in the latex composition include those available from Akzo Nobel under the REDICOTE® trademark (such as REDICOTE® 4819, REDICOTE® E-64R, REDICOTE® E-5, REDICOTE® E-9, REDICOTE® E9A, REDICOTE® E-11, REDICOTE® E-16, REDICOTE® E-44, REDICOTE® E-62, REDICOTE® E-120, REDICOTE® E-250, REDICOTE® E-2199, REDICOTE® E-4868, REDICOTE® E-7000, REDICOTE® C-346, REDICOTE® C-404, REDICOTE® C-450, and REDICOTE® C-471), surfactants available from Ingevity under the INDULIN® and AROSURF® trademarks (such as INDULIN® 201, INDULIN® 202, INDULIN® 206, INDULIN® 814, INDULIN® AA-54, INDULIN® AA-57, INDULIN® AA-78, INDULIN® AA-86, INDULIN® AA-89, INDULIN® AMS, INDULIN® DF-30, INDULIN® DF-40, INDULIN® DF-42, INDULIN® DF-60, INDULIN® DF-80, INDULIN® EX, INDULIN® FRC, INDULIN® HFE, INDULIN® IFE, INDULIN® MQK, INDULIN® MQK-1M, INDULIN® MQ3, INDULIN® QTS, INDULIN® R-20, INDULIN® FST (also known as PC-1542), INDULIN® SA-L, INDULIN® SBT, INDULIN® W-1, and INDULIN® W-5), ASFIER® N480 available from Kao Specialties Americas, CYPRO™ 514 available from Cytec Industries, polyethyleneimines such as those available from BASF under the POLYMIN® trademark (such as POLYMIN® SK, POLYMIN® SKA, POLYMIN® 131, POLYMIN® 151, POLYMIN® 8209, POLYMIN® P, and POLYMIN® PL), polyvinylamines such as those available from BASF under the CATIOFAST® trademark (such as CATIOFAST® CS, CATIOFAST® FP, CATIOFAST® GM, and CATIOFAST® PL), and tall oil fatty acids.

In some embodiments, the asphalt emulsion can be an anionic asphalt emulsion. The anionic asphalt emulsion generally has a high pH, such as a pH greater than 7. For example, the asphalt emulsion can have a pH of 7.5 or greater, 8 or greater, 8.5 or greater, 9 or greater, or 9.5 or greater. In some examples, the asphalt emulsion can have a pH of 12 or less, 11.5 or less, 11 or less, 10.5 or less, 10 or less, 9.5 or less, 9 or less, 8.5 or less, or 8 or less. In some embodiments, the asphalt emulsion can have a pH of from greater than 7 to 12, from 7.5 to 11, or from 8 to 11.

In some embodiments, the asphalt emulsion can be a cationic asphalt emulsion. The cationic asphalt emulsion generally has a low pH, such as a pH of 7 or less. For example, the asphalt emulsion can have a pH of 6.5 or less, 6 or less, 5.5 or less, 5 or less, 4.5 or less, 4 or less, 3.5 or less, 3 or less, or 2.5 or less. In some examples, the asphalt emulsion can have a pH of 1.5 or greater, 2 or greater, 2.5 or greater, 3 or greater, 3.5 or greater, 4 or greater, 4.5 or greater, 5 or greater, 5.5 or greater, 6 or greater, 6.5 or greater, or 7 or greater. In some embodiments, the asphalt emulsion can have a pH of from 1.5 to 7, from 2 to 6.5, from 1.5 to 6, from 2 to 6, from 3 to 7, from 3 to 6.5, from 3 to 6, from 4 to 7, from 4 to 6.5, or from 4 to 6.

As described herein, the asphalt compositions can include a dispersible copolymer powder as described herein. The amount of dispersible copolymer powder present in the asphalt compositions can depend on the end-use of the asphalt composition. For example, the dispersible copolymer powder can be in an amount of 0.05% or greater by weight, based on the weight of the asphalt composition. In some embodiments, the asphalt composition can include the dispersible copolymer powder in an amount of 0.5% or greater, 1% or greater, 1.5% or greater, 2% or greater, 2.5% or greater, 3% or greater, 3.5% or greater, 4% or greater, 4.5% or greater, 5% or greater, 6% or greater, 7% or greater, 8% or greater, 9% or greater, 10% or greater, 11% or greater, 12% or greater, 13% or greater, 14% or greater, 15% or greater, 20% or greater, 25% or greater, 30% or greater, 35% or greater, or 40% or greater by weight, based on the weight of the asphalt composition. In some embodiments, the asphalt composition can include the dispersible copolymer powder in an amount of 95% or less, 90% or less, 80% or less, 60% or less, 50% or less, 45% or less, 40% or less, 35% or less, 30% or less, 25% or less, 20% or less, 18% or less, 15% or less, 12% or less, 10% or less, 8% or less, 7% or less, 6% or less, 5% or less, 4% or less, 3% or less, 2% or less, or 1% or less by weight, based on the weight of the asphalt composition. In some embodiments, the asphalt composition can include the dispersible copolymer powder in an amount of from 0.05% to 90%, from 0.5% to 50%, from 0.5% to 40%, from 1% to 40%, from 1% to 35%, from 0.5% to 15%, from 0.5% to 12%, from 0.5% to 10%, from 1% to 15%, or from 1% to 10% by weight, based on the weight of the asphalt composition. The dispersible copolymer powder and the asphalt can be present in a weight ratio of from 1:100 to 40:100, from 1:100 to 10:100, or from 2:100 to 5:100.

The asphalt compositions can further include an additive to decrease the drying time of the asphalt compositions. The additive can include a polyamine such as a polyalkyleneimine. Suitable polyalkyleneimine for use in the asphalt compositions are described in U.S. Provisional Application No. 62/648,639 to Avramidis et al., U.S. Pat. No. 8,193,144 to Tanner, et al., U.S. Pat. No. 7,268,199 to Andre, et al., U.S. Pat. No. 7,736,525 to Thankachan, et al, U.S. Pat. No. 6,811,601 to Borzyk, et al. and WO 99/67352, all of which are incorporated herein by reference for their teaching of alkoxylated polyalkyleneimines. In particular embodiments, the asphalt composition can contain an alkoxylated polyalkyleneimine such as an ethoxylated polyethyleneimine, a propoxylated polyethyleneimine, a butoxylated polyethyleneimine, or a combination thereof. The polyalkyleneimines can be present in the composition at from 0% by weight to 10% by weight, or from 0.1% by weight to 10% by weight, based on the dry weight of the composition.

The asphalt compositions described herein can also contain a base. In some embodiments, the base can be a volatile base. Suitable bases can be selected on the basis of several factors, including their alkalinity and volatility. Exemplary bases include, but are not limited to, ammonia, lower alkylamines such as dimethylamine, triethylamine, and diethylamine, ethanolamine, diethanolamine, triethanolamine, morpholine, aminopropanol, 2-amino-2-methyl-1-propanol, 2-dimethylaminoethanol, and combinations thereof. In certain embodiments, the base is ammonia. In some cases, ammonia is the sole base present in the composition. Alternatively, ammonia can be incorporated in admixture with other bases, such as alkali metal hydroxides, or combinations thereof.

The asphalt compositions can also include a photoinitiator. Photoinitiators are compounds that can generally bring about a crosslinking reaction of a polymer by exposure to sunlight. Suitable photoinitiators for use in the asphalt compositions are described in U.S. Provisional Application No. 62/648,639 to Avramidis et al. and EP-A-209 831. Examples of suitable compounds for use as a photoinitiator are those having a diaryl ketone structure, such as benzophenone, thioxanthone, and derivatives thereof. The photoinitiators are used in the asphalt composition in an amount of from 0.01% to 5% by weight, based on the asphalt composition.

The asphalt compositions can include a basic salt. Suitable basic salts can include the salt of a strong base and a weak acid. In some embodiments, the asphalt compositions can include a basic salt selected from sodium sulfate, potassium sulfate, magnesium sulfate, aluminum sulfate, iron sulfate, cobalt sulfate, barium sulfate, beryllium sulfate, copper sulfate, zinc sulfate, manganese sulfate, sodium carbonate, sodium bicarbonate, potassium carbonate, potassium bicarbonate, potassium sodium carbonate, sodium bisulfate, ammonium bisulfite, potassium bisulfate, potassium sulfite, sodium sulfite, potassium hydrogen sulfite, ammonium sulfite, disodium hydrogen phosphate, sodium dihydrogen phosphate, dipotassium hydrogen phosphate, and mixtures thereof. In some embodiments, the basic salt can include aluminum sulfate. The basic salt, such as aluminum sulfate can be in an amount of from 0.01% to 5%, 0.05% to 4%, 0.1% to 5%, 0.2% to 4%, or 0.3% to 3%, by weight, based on the weight of the asphalt composition. The asphalt formulation can include the basic salt in an amount such that the pH of the asphalt formulation has a pH of from 1.5 to 10, such as from 1.5 to 6 or from 8 to 10.

The asphalt compositions can include a solvent such as water to disperse or emulsify the polymer and/or the asphalt. The asphalt composition can include water in an amount of 1% to 35%, 5% to 30%, or 5% to 25% by weight, based on the weight of the asphalt composition. In some instances, the asphalt compositions can include a second solvent, in addition to water. For example, the asphalt composition can include a rejuvenating (or recycling) agent that includes a non-aqueous solvent and optionally water. The rejuvenating agent can include any known rejuvenating agent appropriate for the type of asphalt surface that the asphalt compositions are applied to. Rejuvenating (recycling) agents are classified into types such as RA-1, RA-5, RA-25, and RA-75 as defined by ASTM D4552. The rejuvenating agent used herein can be a material that resembles the maltene fraction of asphalt such as a RA-1 rejuvenating agent, a RA-5 rejuvenating agent, or mixtures thereof. In some examples, the rejuvenating agent is a RA-1 recycling agent such as those available as RA-1 from vendors such as San Joaquin Refining or Tricor Refining or under the trade name HYDROLENE® (such as HYDROLENE® HT100T) from Sunoco.

The amount of rejuvenating agent can be from 0% to 15% by weight, such as from 2 to 15% or 2 to 8% by weight, or from 3% to 6% by weight (e.g. 5% by weight) of the asphalt composition.

The asphalt compositions can be vulcanized or cured to crosslink the copolymer in the latex composition, thereby increasing the tensile strength and elongation of the copolymer. In some embodiments, the asphalt compositions can include vulcanizing (curing) agents, vulcanization accelerators, antireversion agents, or a combination thereof. In some embodiments, the vulcanizing agents, vulcanization accelerators, and/or antireversion agents can be included in the latex composition. Exemplary vulcanizing agents are sulfur curing agents and include various kinds of sulfur such as sulfur powder, precipitated sulfur, colloidal sulfur, insoluble sulfur and high-dispersible sulfur; sulfur halides such as sulfur monochloride and sulfur dichloride; sulfur donors such as 4,4′-dithiodimorpholine; selenium; tellurium; organic peroxides such as dicumyl peroxide and di-tert-butyl peroxide; quinone dioximes such as p-quinone dioxime and p,p′-dibenzoylquinone dioxime; organic polyamine compounds such as triethylenetetramine, hexamethylenediamine carbamate, 4,4′-methylenebis(cyclohexylamine) carbamate and 4,4′-methylenebis-o-chloroaniline; alkylphenol resins having a methylol group; and mixtures thereof. The vulcanizing agent can be present from 0.01 to 1% or from 0.01 to 0.6% by weight, based on the weight of the asphalt formulation.

Exemplary vulcanization accelerators include sulfenamide-type vulcanization accelerators such as N-cyclohexyl-2-benzothiazole sulfenamide, N-t-butyl-2-benzothiazole sulfenamide, N-oxyethylene-2-benzothiazole sulfenamide, N-oxydiethylene-2-benzothiazole sulfenamide, N-oxydiethylene-thiocarbamyl-N-oxydiethylene sulfenamide, N-oxyethylene-2-benzothiazole sulfenamide and N, N′-diisopropyl-2-benzothiazole sulfenamide; guanidine-type vulcanization accelerators such as diphenylguanidine, di-o-tolylguanidine and di-o-tolylbiguanidine; thiourea-type vulcanization accelerators such as thiocarboanilide, di-o-tolylthiourea, ethylenethiourea, diethylenethiourea, dibutylthiourea and trimethylthiourea; thiazole-type vulcanization accelerators such as 2-mercaptobenzothiazole, dibenzothiazyl disulfide, 2-mercaptobenzothiazole zinc salt, 2-mercaptobenzothiazole sodium salt, 2-mercaptobenzothiazole cyclohexylamine salt, 4-morpholinyl-2-benzothiazole disulfide and 2-(2,4-dinitrophenylthio)benzothiazole; thiadiazine-type vulcanization accelerators such as activated thiadiazine; thiuram-type vulcanization accelerators such as tetramethylthiuram monosulfide, tetramethylthiuram disulfide, tetraethylthiuram disulfide, tetrabutylthiuram disulfide and dipentamethylenethiuram tetrasulfide; dithiocarbamic acid-type vulcanization accelerators such as sodium dimethyldithiocarbamate, sodium diethyldithiocarbamate, sodium di-n-butyldithiocarbamate, lead dimethyldithiocarbamate, lead diamyldithiocarbamate, zinc diamyldithiocarbamate, zinc dimethyldithiocarbamate, zinc diethyldithiocarbamate, zinc di-n-butyldithiocarbamate, zinc pentamethylene dithiocarbamate, zinc ethylphenyldithiocarbamate, tellurium diethyldithiocarbamate, bismuth dimethyldithiocarbamate, selenium dimethyldithiocarbamate, selenium diethyldithiocarbamate, cadmium diethyldithiocarbamate, copper dimethyldithiocarbamate, iron dimethyldithiocarbamate, diethylamine diethyldithiocarbamate, piperidinium pentamethylene dithiocarbamate and pipecoline pentamethylene dithiocarbamate; xanthogenic acid-type vulcanization accelerators such as sodium isopropylxanthogenate, zinc isopropylxanthogenate and zinc butylxanthogenate; isophthalate-type vulcanization accelerators such as dimethylammonium hydrogen isophthalate; aldehyde amine-type vulcanization accelerators such as butyraldehyde-amine condensation products and butyraldehyde-monobutylamine condensation products; and mixtures thereof. The vulcanization accelerator can be present in an amount of from 0.01 to 1% or from 0.01 to 0.6% by weight, based on the weight of the asphalt formulation.

Antireversion agents can also be included to prevent reversion, i.e., an undesirable decrease in crosslink density. Suitable antireversion agents include zinc salts of aliphatic carboxylic acids, zinc salts of monocyclic aromatic acids, bismaleimides, biscitraconimides, bisitaconimides, aryl bis-citraconamic acids, bissuccinimides, and polymeric bissuccinimide polysulfides (e.g., N, N′-xylenedicitraconamides). The antireversion agent can be present in an amount of from 0.01 to 1% or from 0.01 to 0.6% by weight, based on the weight of the asphalt composition.

The asphalt compositions can further include one or more additional additives. Suitable additional additives include chloride salts, thickeners, and fillers. Chloride salts can be added, for example to improve emulsifiability, in an amount of up to 1 part by weight. Suitable chloride salts include sodium chloride, potassium chloride, calcium chloride, aluminum chloride, or mixtures thereof. Thickeners can be added in an amount of 0.5 parts by weight or greater and can include associative thickeners, polyurethanes, alkali swellable latex thickeners, cellulose, cellulose derivatives, modified cellulose products, plant and vegetable gums, starches, alkyl amines, polyacrylic resins, carboxyvinyl resins, polyethylene maleic anhydrides, polysaccharides, acrylic copolymers, hydrated lime (such as cationic and/or nonionic lime), or mixtures thereof. In some embodiments, the asphalt compositions described herein do not include a thickener. Mineral fillers and/or pigments can include calcium carbonate (precipitated or ground), kaolin, clay, talc, diatomaceous earth, mica, barium sulfate, magnesium carbonate, vermiculite, graphite, carbon black, alumina, silicas (fumed or precipitated in powders or dispersions), colloidal silica, silica gel, titanium oxides (e.g., titanium dioxide), aluminum hydroxide, aluminum trihydrate, satine white, magnesium oxide, hydrated lime, limestone dust, Portland cement, silica, alum, fly ash, or mixtures thereof. Fillers such as mineral fillers and carbon black can be included in an amount of up to 5 parts by weight or up to 2 parts by weight.

The asphalt compositions can also include an aggregate. The aggregate can be of varying sizes as would be understood by those of skill in the art. Any aggregate that is traditionally employed in the production of bituminous paving compositions can be used, including dense-graded aggregate, gap-graded aggregate, open-graded aggregate, reclaimed asphalt pavement, and mixtures thereof. In some embodiments, the asphalt composition can include an aggregate in an amount of 1% to 90% by weight, based on the weight of the asphalt composition. In some embodiments, the asphalt composition can include an aggregate in an amount of 90% or less, 85% or less, 80% or less, 75% or less, 70% or less, 65% or less, 60% or less, 55% or less, 50% or less, or 45% or less by weight, based on the weight of the asphalt formulation. In some embodiments, the asphalt composition can include an aggregate in an amount of 5% or greater, 10% or greater, 15% or greater, 20% or greater, 25% or greater, 30% or greater, 35% or greater, 40% or greater, 45% or greater, or 50% or greater by weight, based on the weight of the asphalt composition.

In some embodiments, the asphalt composition can have a pH of 7 or less. For example, the asphalt composition can have a pH of 6.5 or less, 6 or less, 5.5 or less, 5 or less, 4.5 or less, 4 or less, 3.5 or less, 3 or less, or 2.5 or less. In some examples, the asphalt composition can have a pH of 1.5 or greater, 2 or greater, 2.5 or greater, 3 or greater, 3.5 or greater, 4 or greater, 4.5 or greater, 5 or greater, 5.5 or greater, 6 or greater, 6.5 or greater, or 7 or greater. In some embodiments, the asphalt composition can have a pH of from 1.5 to 7, from 2 to 6.5, from 1.5 to 6, from 2 to 6, from 3 to 7, from 3 to 6.5, from 3 to 6, from 4 to 7, from 4 to 6.5, or from 4 to 6.

Methods

Methods for preparing the dispersible copolymer powders and asphalt compositions described herein are also provided. In the methods for preparing the dispersible copolymer powders, the core polymer can be prepared by polymerizing the monomers using free-radical emulsion polymerization. The monomers for the core polymer can be prepared as an aqueous dispersions at a suitable temperature. The polymerization can be carried out at low temperature (i.e., cold polymerization) or at high temperature method (i.e., hot polymerization). In some embodiments, polymerization can be carried out at low temperature such as 30° C. or less (for example from 2° C. to 30° C., 2° C. to 25° C., 5° C. to 30° C., or 5° C. to 25° C.). In some embodiments, polymerization can be carried out at high temperature such as from 40° C. or greater, 50° C. or greater, or 60° C. or greater. In some embodiments, the high temperature can be from 40° C. to 100° C., 40° C. to 95° C., or 50° C. to 90° C. Generally, the emulsion polymerization temperature is from 10° C. to 95° C., from 30° C. to 95° C., or from 75° C. to 90° C.

The polymerization medium can include water alone or a mixture of water and water-miscible liquids, such as methanol. In some embodiments, water is used alone. The emulsion polymerization can be carried out either as a batch, semi-batch, or continuous process. Typically, a semi-batch process is used. In some embodiments, a portion of the monomers can be heated to the polymerization temperature and partially polymerized, and the remainder of the polymerization batch can be subsequently fed to the polymerization zone continuously, in steps or with superposition of a concentration gradient.

The free-radical emulsion polymerization can be carried out in the presence of a free-radical polymerization initiator. The free-radical polymerization initiators that can be used in the process are all those which are capable of initiating a free-radical aqueous emulsion polymerization including alkali metal peroxydisulfates and H₂O₂, or azo compounds. Combined systems can also be used comprising at least one organic reducing agent and at least one peroxide and/or hydroperoxide, e.g., tert-butyl hydroperoxide and the sodium metal salt of hydroxymethanesulfinic acid or hydrogen peroxide and ascorbic acid. Combined systems can also be used additionally containing a small amount of a metal compound which is soluble in the polymerization medium and whose metallic component can exist in more than one oxidation state, e.g., ascorbic acid/iron(II) sulfate/hydrogen peroxide, where ascorbic acid can be replaced by the sodium metal salt of hydroxymethanesulfinic acid, sodium sulfite, sodium hydrogen sulfite or sodium metal bisulfite and hydrogen peroxide can be replaced by tert-butyl hydroperoxide or alkali metal peroxydisulfates and/or ammonium peroxydisulfates. In the combined systems, the carbohydrate derived compound can also be used as the reducing component. In general, the amount of free-radical initiator systems employed can be from 0.1 to 2%, based on the total amount of the monomers to be polymerized. In some embodiments, the initiators are ammonium and/or alkali metal peroxydisulfates (e.g., sodium persulfate), alone or as a constituent of combined systems. The manner in which the free-radical initiator system is added to the polymerization reactor during the free-radical aqueous emulsion polymerization is not critical. It can either all be introduced into the polymerization reactor at the beginning, or added continuously or stepwise as it is consumed during the free-radical aqueous emulsion polymerization. In detail, this depends in a manner known to an average person skilled in the art both from the chemical nature of the initiator system and on the polymerization temperature. In some embodiments, some is introduced at the beginning and the remainder is added to the polymerization zone as it is consumed. It is also possible to carry out the free-radical aqueous emulsion polymerization under superatmospheric or reduced pressure.

The core polymer can be produced by single stage polymerization or multiple stage polymerization.

One or more surfactants can be included in the aqueous dispersions to improve certain properties of the dispersions, including particle stability. For example, oleic acid, sodium laureth sulfate, and alkylbenzene sulfonic acid or sulfonate surfactants could be used. Examples of commercially available surfactants include Calfoam® ES-303, a sodium laureth sulfate, and Calfax® DB-45, a sodium dodecyl diphenyl oxide disulfonate, both available from Pilot Chemical Company (Cincinnati, Ohio). In general, the amount of surfactants employed can be from 0.01 to 5%, based on the total amount of the monomers to be polymerized.

The polymerization reaction can be conducted in the presence of molecular weight regulators to reduce the molecular weight of the core polymer or other additives such as dispersants, stabilizers, chain transfer agents, buffering agents, salts, preservatives, fire retardants, wetting agents, protective colloids, biocides, crosslinking promoters, antioxidants, antiozonants, prevulcanization inhibitors, and lubricants. In some embodiments, the additives can be added to the latex dispersions after the polymerization reaction. In some embodiments, small amounts (e.g., from 0.01 to 2% by weight based on the total monomer weight) of molecular weight regulators, such as a mercaptan, can optionally be used. Such substances are preferably added to the polymerization zone in a mixture with the monomers to be polymerized and are considered part of the total amount of unsaturated monomers used in the copolymers.

In the case of copolymers derived from styrene and butadiene, the copolymer can be produced by high temperature polymerization (e.g., polymerization at a temperature of 40° C. or greater, such as at a temperature of from 40° C. to 100° C.) or by low temperature polymerization (e.g., polymerization at a temperature of less than 40° C., such as at a temperature of from 5° C. to 25° C.). As such, copolymers derived from styrene and butadiene can include varying ratios of cis-1,4 butadiene units to trans-1,4 butadiene units.

As described above, copolymers derived from styrene and butadiene can be polymerized in a continuous, semi-batch or batch process. Once the desired level of conversion is reached, the polymerization reaction can be terminated by the addition of a shortstop to the reactor. The shortstop reacts rapidly with free radicals and oxidizing agents, thus destroying any remaining initiator and polymer free radicals and preventing the formation of new free radicals. Exemplary shortstops include organic compounds possessing a quinonoid structure (e.g., quinone) and organic compounds that may be oxidized to a quinonoid structure (e.g., hydroquinone), optionally combined with water soluble sulfides such as hydrogen sulfide, ammonium sulfide, or sulfides or hydrosulfides of alkali or alkaline earth metals; N-substituted dithiocarbamates; reaction products of alkylene polyamines with sulfur, containing presumably sulfides, disulfides, polysulfides and/or mixtures of these and other compounds; dialkylhydroxylamines; N,N′-dialkyl-N,N′-methylenebishydroxylamines; dinitrochlorobenzene; dihydroxydiphenyl sulfide; dinitrophenylbenzothiazyl sulfide; and mixtures thereof. In the case of high temperature polymerizations, polymerization can be allowed to continue until complete monomer conversion, i.e., greater than 99%, in which case a shortstop may not be employed.

Once polymerization is terminated (in either the continuous, semi-batch or batch process), the unreacted monomers can be removed from the copolymer dispersion. For example, butadiene monomers can be removed by flash distillation at atmospheric pressure and then at reduced pressure. Styrene monomers can be removed by steam stripping in a column.

The latex dispersions can be coagulated (agglomerated), e.g., using chemical, freeze or pressure agglomeration, and water removed to produce the desired solids content. In some embodiments, the solids content is 40% or greater, 45% or greater, 50% or greater, 55% or greater, 60% or greater, 65% or greater, 70% or greater, or from greater than 40% to 75%.

An antioxidant can be added to polymers derived from styrene and butadiene to prevent oxidation of the double bonds of the polymer, and can either be added before or after vulcanization of the polymer. The antioxidants can be, for example, substituted phenols or secondary aromatic amines. Antiozonants can also be added to polymers derived from styrene and butadiene to prevent ozone present in the atmosphere from cracking the polymer by cleaving the double bonds in the polymer. Prevulcanization inhibitors can also be added to polymers derived from styrene and butadiene to prevent premature vulcanization or scorching of the polymer.

If desired, polymers derived from styrene and butadiene can be vulcanized or cured to crosslink the polymer thereby increasing the tensile strength and elongation of the rubber by heating the polymer, typically in the presence of vulcanizing agents, vulcanization accelerators, antireversion agents, and optionally crosslinking agents. Exemplary vulcanizing agents are described herein. The vulcanizing agent can be present from 0.1 to 15%, from 0.3 to 10%, or from 0.5 to 5%, by weight based on the weight of the polymer. The vulcanization accelerator can be present within a range of from 0.1 to 15%, from 0.3 to 10%, or from 0.5 to 5%, by weight based on the weight of the polymer. Antireversion agents can also be included in an amount of from 0 to 5%, from 0.1 to 3%, or from 0.1 to 2% by weight based on the weight of the polymer.

In some embodiments, the core polymer can be dispersed in an aqueous medium to form an aqueous dispersion. The aqueous dispersion can further include an aggregate, a filler, a pigment, a dispersing agent, a thickener, a defoamer, a surfactant, a biocide, a coalescing agent, a flame retardant, a stabilizer, a curing agent, a flow agent, a leveling agent, a hardener, or a combination thereof.

Examples of suitable thickeners include hydrophobically modified ethylene oxide urethane (HEUR) polymers, hydrophobically modified alkali soluble emulsion (HASE) polymers, hydrophobically modified hydroxyethyl celluloses (HMHECs), hydrophobically modified polyacrylamide, and combinations thereof. Defoamers serve to minimize frothing during mixing. Suitable defoamers include organic defoamers such as mineral oils, silicone oils, and silica-based defoamers. Exemplary silicone oils include polysiloxanes, polydimethylsiloxanes, polyether modified polysiloxanes, and combinations thereof. Exemplary defoamers include BYK®-035, available from BYK USA Inc., the TEGO® series of defoamers, available from Evonik Industries, the DREWPLUS® series of defoamers, available from Ashland Inc., and FOAMASTER® NXZ, available from BASF Corporation.

Other suitable additives that can optionally be incorporated into the latex composition includes coalescing agents (coalescents), pH modifying agents, biocides, co-solvents and plasticizers, crosslinking agents (e.g., quick-setting additives, for example, a polyamine such as polyethyleneimine), dispersing agents, rheology modifiers, wetting and spreading agents, leveling agents, conductivity additives, adhesion promoters, anti-blocking agents, anti-cratering agents and anti-crawling agents, anti-freezing agents, corrosion inhibitors, anti-static agents, flame retardants and intumescent additives, dyes, optical brighteners and fluorescent additives, UV absorbers and light stabilizers, chelating agents, cleanability additives, flatting agents, humectants, insecticides, lubricants, odorants, oils, waxes and slip aids, soil repellants, stain resisting agents, and combinations thereof.

Suitable coalescents, which aid in film formation during drying, include ethylene glycol monomethyl ether, ethylene glycol monobutyl ether, ethylene glycol monoethyl ether acetate, ethylene glycol monobutyl ether acetate, diethylene glycol monobutyl ether, diethylene glycol monoethyl ether acetate, dipropylene glycol monomethyl ether, 2,2,4-trimethyl-1,3-pentanediol monoisobutyrate, and combinations thereof.

Examples of suitable pH modifying agents include bases such as sodium hydroxide, potassium hydroxide, amino alcohols, monoethanolamine (MEA), diethanolamine (DEA), 2-(2-aminoethoxy)ethanol, diisopropanolamine (DIPA), 1-amino-2-propanol (AMP), ammonia, and combinations thereof. Suitable biocides can be incorporated to inhibit the growth of bacteria and other microbes in the coating composition during storage. Exemplary biocides include 2-[(hydroxymethyl)amino]ethanol, 2-[(hydroxymethyl) amino]2-methyl-1-propanol, o-phenylphenol, sodium salt, 1,2-benzisothiazolin-3-one, 2-methyl-4-isothiazolin-3-one (MIT), 5-chloro2-methyland-4-isothiazolin-3-one (CIT), 2-octyl-4-isothiazolin-3-one (OIT), 4,5-dichloro-2-n-octyl-3-isothiazolone, as well as acceptable salts and combinations thereof. Suitable biocides also include biocides that inhibit the growth of mold, mildew, and spores thereof in the coating. Examples of mildewcides include 2-(thiocyanomethylthio)benzothiazole, 3-iodo-2-propynyl butyl carbamate, 2,4,5,6-tetrachloroisophthalonitrile, 2-(4-thiazolyl)benzimidazole, 2-N-octyl4-isothiazolin-3-one, diiodomethyl p-tolyl sulfone, as well as acceptable salts and combinations thereof. In certain embodiments, the coating composition contains 1,2-benzisothiazolin-3-one or a salt thereof. Biocides of this type include PROXEL® BD20, commercially available from Arch Chemicals, Inc. The biocide can alternatively be applied as a film to the coating and a commercially available film-forming biocide is Zinc Omadine® commercially available from Arch Chemicals, Inc. Exemplary crosslinking agents include dihydrazides (e.g., dihydrazides of adipic acid, succinic acid, oxalic acid, glutamic acid, or sebastic acid). The dihydrazides can be used, for example, to crosslink diacetone acrylamide or other crosslinkable monomers.

The latex composition can include a surfactant. Suitable surfactants include nonionic surfactants and anionic surfactants. Examples of nonionic surfactants are alkylphenoxy polyethoxyethanols having alkyl groups of about 7 to about 18 carbon atoms, and having from about 6 to about 60 oxyethylene units; ethylene oxide derivatives of long chain carboxylic acids; analogous ethylene oxide condensates of long chain alcohols, and combinations thereof. Exemplary anionic surfactants include ammonium, alkali metal, alkaline earth metal, and lower alkyl quaternary ammonium salts of sulfosuccinates, higher fatty alcohol sulfates, aryl sulfonates, alkyl sulfonates, alkylaryl sulfonates, and combinations thereof. In certain embodiments, the composition comprises a nonionic alkylpolyethylene glycol surfactant, such as LUTENSOL® TDA 8 or LUTENSOL® AT-18, commercially available from BASF SE. In certain embodiments, the composition comprises an anionic alkyl ether sulfate surfactant, such as DISPONIL® FES 77, commercially available from BASF SE. In certain embodiments, the composition comprises an anionic diphenyl oxide disulfonate surfactant, such as CALFAX® DB-45, commercially available from Pilot Chemical.

The method of making the dispersible copolymer powder can include blending the latex dispersion comprising the core polymer with a water soluble protective colloid to form a blend. In some embodiments, a solution of the protective colloid can be mixed with the latex composition of the core polymer to form the blend. The blend can also be mixed with one or more additional components such as anti-caking agents. The viscosity of the blend to be dried can be adjusted via the solids content so that a value of less than 1000 mPa·s (Brookfield viscosity at 20 revolutions and 23° C.), for example less than 250 mPa·s, is obtained. The solids content of the dispersion blend to be spray-dried can be from 20% to 75% by weight, such as from 40% to 75% by weight or from 40% to 60% by weight, based on the total weight of the blend.

The method can include removing water from the blend to form the dispersible copolymer powder. In some embodiments, water can be removed by spray drying the blend. In each case, the core polymer is mixed with the protective colloid (also referred to herein as a spray drying aid) to form a spray feed. Spray drying takes place in conventional spray-drying installations, with atomization by any suitable means, for example, single-fluid, two-fluid or multifluid nozzles, or with a rotating disk. The spray feed can be dried at a temperature of 50° C. or greater, such as from 50° C. to 150° C., or from 60° C. to 140° C. The inlet temperature and the outlet temperature of the spray drier are not critical but can be of such a level to provide the desired particle size. In this regard, the inlet and outlet temperatures can be adjusted depending on the melting characteristics of the formulation components and the composition of the spray feed. In some cases, the inlet temperature can be between 60° C. and 170° C., with the outlet temperatures of about 40° C. to 120° C. depending on the composition of the feed and the desired particulate characteristics. In some examples, these temperatures can be from 90° C. to 120° C. for the inlet and from 60° C. to 90° C. for the outlet. The flow rate which is used in the spray drying equipment can generally be about 3 ml per minute to about 30 ml per minute, such as from 15 to 25 ml/min, or from 20 to 25 ml/min. The atomizer air flow rate can vary between values of 25 liters per minute to about 50 liters per minute. Commercially available spray dryers are known to those in the art including Niro Atomizer or Mobile Minor Typ MM-I from the company GEA Niro with nitrogen, air, or nitrogen enriched air as drying gas.

As described herein, an anti-caking agent (anti-blocking agent) can be added to the polymer powder to increase storage stability, for example to prevent caking and blocking and/or to improve the flow properties of the powder. This addition can be carried out while the powder is still finely dispersed, for example still suspended in the drying gas. In some embodiments, the anti-caking agent (anti-blocking agent) can be added to the dispersion blend comprising the core polymer (as a latex) and the protective colloid. Overall, the anticaking agent can be added to the blend prior to, during, or after spray drying or combinations thereof.

After drying, the fine powder obtained can be conveyed, by a fan, into a cyclone, where it can be separated from the hot air and other vapors.

Other methods of removing water from the blend can include fluidized-bed drying, drum drying, or freeze drying. The blend, however, is preferably spray dried.

The blend comprising the core polymer and protective colloid is dried to a suitable loss on drying (LOD), for example to a moisture content of less than 6% by weight to form the dispersible copolymer powder. For example, the moisture content of the dispersible copolymer powder can be less than 5% by weight, and preferably less 3% by weight, more preferably less than 2% by weight of the dispersible copolymer powder. In some instances the moisture content can be as low as 1% by weight. Of course, the moisture content is, at least in part, dictated by the formulation and is controlled by the process conditions employed, e.g., inlet temperature, feed concentration, pump rate, and blowing agent type, concentration and post drying. The dispersible copolymer powder possesses a moisture content that allows the powder to remain chemically and physically stable during storage at ambient temperature and easily dispersible.

The bulk density and the flowability of the dispersible copolymer powder can be determined according to ASTM B 215 and D 1895 respectively at 23° C. and 50% R.H.

As described herein, the dispersible copolymer powders can be used in asphalt compositions. The asphalt compositions comprising the dispersible copolymer powders can be prepared at an elevated temperature, for example, from 160° C. to 200° C. (hot-mix asphalt), from 120° C. to 160° C. (warm-mix asphalt), or at temperatures below 120° C. (e.g., from 5° C. to less than 100° C., from 10° C. to 90° C., or from 20° C. to 85° C.). In some embodiments, the dispersible copolymer powders can be used in asphalt emulsions prepared at less than 100° C., e.g., at ambient temperature, to produce a polymer-modified asphalt emulsion.

The method of preparing the polymer-modified asphalt emulsions can include contacting asphalt with a dispersible copolymer powder as described herein. The particular components, including the asphalt, the dispersible copolymer powder, and the optional additional components can be mixed together by any means known in the art. The particular components can be mixed together in any order.

The dispersible copolymer powders can provide polymer-modified asphalt compositions with improved viscosity. In some embodiments, the addition of the dispersible copolymer powders increases the viscosity of the asphalt by 100% or less at 135° C. within 2 hours of mixing with asphalt. In specific examples, the polymer-modified asphalt compositions described herein can have a viscosity of of 2500 cp or less, 2000 cp or less, 1500 cp or less, 1250 cp or less, 1000 cp or less, 950 cp or less, 900 cp or less, 850 cp or less, 800 cp or less, 750 cp or less, 700 cp or less, 650 cp or less, 600 cp or less, 550 cp or less, 500 cp or less, 400 cp or less, 250 cp or greater, 300 cp or less, or 200 cp or less, at 135° C. as determined using a Brookfield viscometer, spindle #3 at 20 rpm. In some embodiments, the asphalt compositions can have a viscosity of 100 cp or greater, such as 150 cp or greater, 200 cp or greater, 250 cp or greater, 300 cp or greater, 350 cp or greater, 400 cp or greater, 450 cp or greater, 500 cp or greater, 600 cp or greater, 700 cp or greater, 800 cp or greater, 900 cp or greater, 1000 cp or greater, 1500 cp or greater, or 2000 cp or greater, at 135° C. as determined using a Brookfield viscometer, spindle #3 at 20 rpm. In some embodiments, the viscosity of the asphalt compositions can be from 100 cp to 2500 cp, for example, 400 cp to 2500 cp, 500 cp to 2500 cp, 500 cp to 2000 cp, 400 cp to 2000 cp, 500 cp to 1500 cp, 400 cp to 1500 cp, 400 cp to 1000 cp, 200 cp to 2000 cp, 200 cp to 1500 cp, or 100 cp to 1000 cp, at 135° C. as determined using a Brookfield viscometer, spindle #3 at 20 rpm. In some embodiments, the improvements in viscosity of the asphalt compositions can be obtained for compositions comprising at least 3% by weight or greater of the dispersible copolymer powder.

The asphalt compositions (such as the asphalt emulsions) described herein can adhere to the standards of ASTM D977, ASTM D2397, AASHTO M140, and AASHTO M208.

The asphalt composition can be used to prepare hot mix asphalt compositions. A hot mix asphalt can be prepared, for example, by blending asphalt and the dispersible copolymer powders as described herein at a blending temperature exceeding the boiling point of water. In some embodiments, the asphalt composition can have a pH of 7 or less as described herein. The blending temperature can be 150° C. or greater or 160° C. or greater and 200° C. or less. The hot mix asphalt composition is substantially free of water and can have, for example, a viscosity of 3000 cp or less, 2500 cp or less, 2000 cp or less, 1500 cp or less, 1200 cp or less, 1000 cp or less, 800 cp or less, or 600 cp or less at 135° C., at 60° C. as determined using a Brookfield viscometer, spindle #3 at 20 rpm. In some embodiments, the hot-mix asphalt composition can have a viscosity of 100 cp or greater, 150 cp or greater, 250 cp or greater, 400 cp or greater, or 500 cp or greater, at 135° C. as determined using a Brookfield viscometer, spindle #3 at 20 rpm. In some embodiments, the viscosity of the hot-mix asphalt composition can be from 100 cp to 2500 cp, for example, 100 cp to 2000 cp, 100 cp to 1500 cp, 500 cp to 1500 cp, or 500 cp to 1000 cp, at 135° C. as determined using a Brookfield viscometer, spindle #3 at 20 rpm. In some embodiments, the improvements in viscosity of the asphalt compositions can be obtained for compositions comprising at least 3% by weight or greater of the dispersible copolymer powder.

The asphalt compositions disclosed herein may have a smooth texture compared to the grainy texture of, for instance, a styrene-butadiene latex modified asphalts. Additionally, the asphalt compositions disclosed herein can have a performance grade (PG) increase of at least 1 PG or at least 2 PG above that of a latex modified asphalt. The improvement can be a 1 PG or more improvement in the fresh Strategic Highway Research Program (SHRP) high temperature, the Rolling Thin-Film Oven (RTFO) SHRP high temperature, or both. A standard NUSTAR 64-22 asphalt without the polymer has an SHRP High Temperature of 64° C. Performance Grade improvements are measured in increments of 6° C. Accordingly, a polymer-modified NUSTAR 64-22 having an SHRP High Temperature of 70° C. would be 1 PG improvement over the comparative, standard NUSTAR 64-22 without the polymer. Similarly, a polymer-modified NUSTAR 64-22 having an SHRP High Temperature of 76° C. would be 2 PG improvements over the comparative, standard NUSTAR 64-22 without the polymer. In some embodiments, the polymer-modified asphalt compositions as described herein has a fresh SHRP high temperature of 70° C. or greater, preferably 76° C. or greater. In some embodiments, the polymer-modified asphalt compositions as described herein has a RTFO SHRP high temperature of 76° C. or greater. In some embodiments, the improvements in SHRP High Temperature and/or RTFO SHRP high temperature of the asphalt compositions can be obtained for compositions comprising at least 3% by weight or greater of the dispersible copolymer powder.

Methods of using the asphalt compositions described herein are disclosed. The asphalt compositions can be applied to a surface to be treated, restored, or sealed. Prior to application of the asphalt composition, the surface to be treated is usually cleaned to remove excess surface dirt, weeds, and contaminants by, for example, brushing the surface, blasting the surface with compressed air, or washing the surface. The asphalt compositions can be applied using any suitable method for applying a liquid to a porous surface, such as brushing, wiping and drawing, or spraying.

In some embodiments, the asphalt compositions, once applied, wet the surface thereby forming a layer on at least a portion and typically at least a substantial portion (e.g. more than 50%) of the surface. In some embodiments, when asphalt emulsions are applied to a surface, water loss occurs in the emulsion, primarily due to adsorption of the water. The water also delivers the asphalt and the latex composition to the surface. In some embodiments, the asphalt emulsion penetrates and adheres to the surface it is applied to, cures in a reasonably rapid time, and provides a water-tight and air-tight barrier on the surface. The asphalt emulsion layer also promotes adhesion between the older surface and the later applied surface treatment layer. It is desirable for the asphalt formulations to be easily applied and have an adequate shelf life.

An aggregate can be blended into the asphalt composition before application to a surface. In some embodiments, the aggregate can be applied to the asphalt composition after it is applied to a surface. For example, sand can be applied to the asphalt composition after it is applied to a surface, for example, if the composition is to be used as a tack coat, to reduce the tackiness of the surface. The asphalt composition and optionally the aggregate can be compacted after application to the surface as would be understood by those of skill in the art.

The asphalt compositions can be applied for use in a pavement or paved surface. A pavement surface or a paved surface is a hard surface that can bear pedestrian or vehicular travel can include surfaces such as motorways/roads, parking lots, bridges/overpasses, runways, driveways, vehicular paths, running paths, walkways, and the like. The asphalt compositions can be applied directly to an existing paved surface or can be applied to an unpaved surface. In some embodiments, the asphalt compositions can be applied to an existing paved layer as a tie layer, and a new layer comprising asphalt such as a hot mix layer is applied to the tie layer. The asphalt compositions can be applied to a surface “cold,” i.e., at a temperature below 40° C., or can be applied to at an elevated temperature, for example, from 50° C. to 120° C., from 55° C. to 100° C., or from 60° C. to 80° C.

In some embodiments, the asphalt compositions can be used as a tack coat or coating. The tack coat is a very light spray application of diluted asphalt emulsion that can be used to promote a bond between an existing surface and the new asphalt application. The tack coat acts to provide a degree of adhesion or bonding between asphalt layers, and in some instances, can fuse the layers together. The tack coat also acts to reduce slippage and sliding of the layers relative to other layers in the pavement structure during use or due to wear and weathering of the pavement structure. In some embodiments, the asphalt compositions can be applied to an existing paved layer (such as a hot-mix layer) as a tack coat, and a new layer comprising asphalt such as a hot-mix layer can be applied to the tack coat. As would be understood by those skilled in the art, the tack coat typically does not include aggregate, although sand may be applied to the tack coat after application as mentioned herein.

The tack coat compositions have been shown to be low-tracking or “trackless” coatings and meet an ASTM-D-977 standard. In particular, the asphalt compositions cure/dry quickly. For example, where the asphalt compositions are used as a tack coating, the coating cures quickly such that a pavement layer may be applied to the coating, soon after the asphalt composition is applied to the substrate. The cure rate will depend on the application rate, the dilution ratios used, the base course conditions, the weather, and other similar considerations. If the prepared pavement surface or base course contains excess moisture, the curing time of the asphalt compositions may be increased.

Methods for applying tack coats comprising the asphalt compositions can include applying the tack coat to a surface, wherein the tack coat is at a temperature of from ambient temperature to 130° C., such as from 20° C. to 130° C., from 60° C. to 130° C., or from ambient temperature to 100° C. The applying step can be carried out using a brush, a squeegee, or spray equipment. The surface can be selected from dirt, gravel, slurry seal pavement, chip seal pavement, hot mix asphalt, warm mix asphalt, microsurfaced pavements, and concrete pavements. The methods disclosed herein can further include applying an asphalt composition to the tack coat once the tack coat has become trackless.

In some embodiments, the asphalt compositions can also be used as a fog seal. A fog seal is a surface treatment that applies a light application of the composition to an existing paved surface such as a parking lot to provide an enriched pavement surface that looks fresh and black. In some embodiments, the fog seal would include a filler such as carbon black to blacken the composition. As would be understood by those skilled in the art, the fog seal might not include aggregate. The fog seal compositions, like the bond coat compositions, have also been shown to be low-tracking or “trackless” coatings.

In some embodiments, the asphalt compositions can be used as a chip seal composition. Chip seals are the most common surface treatment for low-volume roads. The chip seal composition can be applied to a surface followed by the application of aggregate. In some embodiments, the asphalt compositions can be used in a microsurfacing application. Microsurfacing is designed for quick traffic return with the capacity of handling high traffic volume roadways. For the microsurfacing composition, aggregate can be mixed in with the cationic asphalt composition before application to a surface.

In some embodiments, the asphalt compositions can be used as a coating for roofs. For example, the asphalt compositions can be used to coat roofing shingles. In these embodiments, higher amounts of the dispersible copolymer powders can be used in the asphalt compositions, such as up to 50 wt %, preferably up to 40 wt % of the dispersible copolymer powders.

By way of non-limiting illustration, examples of certain embodiments of the present disclosure are given below.

### EXAMPLES

### Example 1: Latex SBR Powders for Asphalt Modification

Re-dispersible powders (RDPs) prepared from soft latex particles are of interest in construction applications. However, spray-drying the soft latex particles to provide RDPs having the same (irreversible) film-forming performance as the parent latex remains challenging. For example, the latex dispersion has to be modified to prevent filming and caking (baking) during the spray-drying process. In particular, latex dispersions having a T_{g}<20° C. must be adequately treated with additives to prevent irreversible agglomeration during the drying process. Therefore, additives, such as spray-drying aids and anti-caking agents (also called anti-blocking agents) are usually added to the latex.

Described in this example, is a method for drying styrene butadiene rubber latexes (SBR) to produce RDPs. The resulting SBR powders impart excellent performance to hot mix asphalt. For example, the texture of the modified asphalt is smooth compared to the grainy texture of asphalt modified with SBR. Most surprisingly, the SBR powder modified asphalt has a viscosity that is considerably lower than that of the same asphalt modified by the parent SBR latex. This is significant since polymer modified asphalts with high viscosities have poor workability in paving operations and require extensive compaction in order to meet pavement densities. RDPs are also highly desirable since during storage of polymer-modified asphalt, a significant amount of storage tank volume is needed to accommodate steam generation from the evaporation of the water when latex is added to hot asphalt. The RDPs will, of course, solve this storage problem.

The RDPs described in this example are prepared by spray drying styrene butadiene rubber latexes in the presence of a spray drying aid (SDA). The spray drying aid interacts with the surface of the latex particle and forms a high T_{g}-shell around the soft latex particle. This shell protects the primary latex particles from agglomerating irreversibly during the drying process in the spray drier (pressure and high temperatures). The SDA can be a protective colloid, such as polyvinyl alcohol, polysaccharides, or water soluble synthetic polymers. The SDA is dissolved when the powder particles come in contact with water and the primary particles are re-dispersed. In this example, maltodextrin and polyvinylpyrrolidone (PVP) are used as SDA.

Spray drying was carried out in a laboratory drier (Niro Atomizer, Mobile Minor Typ MM-I) from the company GEA Niro with nitrogen as drying gas. In each case, the latex dispersion was mixed with the spray drying aid. The resulting spray feed (with a solids content of from 40% to 60% by weight) was sprayed using a two fluid nozzle atomizer. The inlet temperature of the drying gas was 130 to 140° C. and its exit temperature was 60 to 70° C. Silica was added as an anti-caking agent in an amount of from 0.5 to 1 wt % (based on the solids content of the spray feed) and Luzenac talc in an amount of 9 wt % (based on the solids content of the spray feed).

Sample 1: an aqueous carboxylated SB dispersion having a T_{g} or −25° C. was mixed with 10 wt % (based on the polymer content of the dispersion) of the spray drying aid, polyvinylpyrrolidone (PVP10). The resulting spray feed with a solids content of 44% was spray dried under the above mentioned conditions, using silica and Luzenac talc as anti-caking agents. The resulting RDP was a white fine powder with good flow properties (almost completely dispersible). No caking or blocking of the RDP was observed.

Sample 2: an aqueous SB dispersion having a T_{g} of −55° C. was mixed with 15 wt % (based on the polymer content of the dispersion) of the spray drying aid, maltodextrin. The resulting spray feed with a solids content of 44% was spray dried under the above-mentioned conditions, using silica and Luzenac talc as anti-caking agents. The resulting RDP was a white fine powder with good flow properties (almost completely dispersible). No caking or blocking of the RDP was observed.

Sample 3: an aqueous carboxylated SB dispersion having a T_{g} of −26° C. was mixed with 15 wt % (based on the polymer content of the dispersion) of the spray drying aid, maltodextrin (M 100). The resulting spray feed with a solids content of 34% was spray dried under the above-mentioned conditions, using silica and Luzenac talc as anti-caking agents. The resulting RDP was a white fine powder with good flow properties and was almost completely redispersible. No caking or blocking of the RDP was observed.

Sample 4: an aqueous carboxylated SB dispersion having a T_{g} of −26° C. was mixed with 15 wt % (based on the polymer content of the dispersion) of the spray drying aid, polyvinylpyrrolidone (Luvitec® K30). The resulting spray feed with a solids content of 35% was spray dried under the above-mentioned conditions, using silica and Luzenac talc as anti-caking agents. The resulting RDP was a white fine powder with good flow properties and was almost completely redispersible. No caking or blocking of the RDP was observed.

Sample 5: an aqueous carboxylated SB dispersion having a T_{g} of −26° C. was mixed with 15 wt % (based on the polymer content of the dispersion) of the spray drying aid, polyvinyl alcohol (Mowiol® 4-88). The resulting spray feed with a solids content of 25% was spray dried under the above-mentioned conditions, using silica and Luzenac talc as anti-caking agents. The resulting RDP was a white fine powder with good flow properties and was moderately redispersible. No caking or blocking of the RDP was observed.

The SBR RDPs were mixed with asphalt under low shear for 2 hours at 170° C. Tables 1-6 provide descriptions and properties of the polymer modified asphalt compositions.

TABLE 1
Polymer modified asphalt compositions.

| Sample | Description | After mixing | After reheating |
|---|---|---|---|
| A | Asphalt emulsion with 3 wt % | Slightly | Slightly grainy |
| | SBR latex (70 wt % solids, 0.9 | grainy | and thick |
| | microns volume-average | | |
| | particle size) | | |
| B | Hot asphalt with 3 wt % RDP | Smooth | Smooth |
| | obtained from carboxylated SB | | |
| | latex | | |
| C | Asphalt emulsion with 3 wt % | Smooth | Smooth |
| | RDP obtained from a lower | | |
| | solids and smaller particle size | | |
| | SBR latex of Sample A (45 | | |
| | wt % solids, 0.085 microns | | |
| | volume-average particle size). | | |

TABLE 2
Properties of polymer modified asphalt compositions.

| | Temp | Spec | | |
|---|---|---|---|---|
| Properties | (° C.) | Limit | Sample A | Sample C |
| Brookfield, mPa · s | 135 | 3000 max | 2734 | 833 |
| (cP) | | | | |
| Phase Angle (delta) | 70 | | 71.9 | 74.2 |
| G*/sin delta @ 10 | 70 | 1.0 min | | |
| rad/sec, kPa | | | | |
| Phase Angle (delta) | 76 | | 74.8 | 72.6 |
| G*/sin delta @ 10 | 76 | 1.0 min | 1.60 | 1.17 |
| rad/sec, kPa | | | | |
| Phase Angle (delta) | 82 | | 77.1 | 69.6 |
| G*/sin delta @ 10 | 82 | 1.0 min | 0.89 | 0.73 |
| rad/sec, kPa | | | | |

Tests on RTFO residue:

| | | | | |
|---|---|---|---|---|
| Phase Angle (delta) | 70 | | 64.0 | 69.6 |
| G*/sin delta @ 10 | 70 | 2.2 min | | |
| rad/sec, kPa | | | | |
| Phase Angle (delta) | 76 | | 67.2 | 72.2 |
| G*/sin delta @ 10 | 76 | 2.2 min | | 3.26 |
| rad/sec, kPa | | | | |
| Phase Angle (delta) | 82 | | 70.0 | 74.1 |
| G*/sin delta @ 10 | 82 | 2.2 min | 2.42 | 1.69 |
| rad/sec, kPa | | | | |
| Phase Angle (delta) | 88 | | 72.5 | |
| G*/sin delta @ 10 | 88 | 2.2 min | 1.35 | |
| rad/sec, kPa | | | | |

DATA SUMMARY

| | | |
|---|---|---|
| SHRP Hi grade | 76 | 76 |
| Temp @ DMA G*/sin d = 1.0 kPa, | 80.8 | 78.0 |
| 10 rad/s, ° C. | | |
| Correlation | −1.00000 | −1.00000 |
| Temp @ RTFO G*/sin d = 2.2 kPa, | 83.0 | 79.6 |
| 10 rad/s, ° C. | | |
| Correlation | −1.00000 | −1.00000 |
| Limiting High Temperature, ° C. | 80.8 | 78.0 |
| Temperature Range, ° C. | 80.8 | 78.0 |

### Example 2: Latex Powders in Bitumen 50/70 and 70/100 (BP)

Samples: Two latex dispersions were dried to powders and examined in two different Bitumen grades (50/70 and 70/100) from BP according to German standard characterization.

Sample D: Bitumen 70/100+3% Sample 1 (SB latex having a T_{g} or −25° C. spray dried with 10 wt % polyvinylpyrrolidone).

Sample E: Bitumen 70/100+Sample 2 spray dried with 15 wt % maltodextrin.

Sample F (control): Bitumen 70/100+3% of the latex precursor of Sample 2. The phrase “latex precursor” as used herein refers to the latex composition prior to drying in the presence of the spray drying aid.

Sample G (control): Bitumen 70/100+3% carboxylated SB latex having a T_{g} or −25° C. (latex precursor of Sample 1).

Sample H (control): Bitumen 70/100+3% maltodextrin (the spray drying agent).

Sample I: Bitumen 50/70+3% Sample 1 (SB latex having a T_{g} or −25° C. spray dried with 10 wt % polyvinylpyrrolidone).

Sample J: Bitumen 50/70+3% Sample 2 spray dried with 15 wt % maltodextrin.

Sample K (control): Bitumen 50/70+3% maltodextrin.

Sample L (control): Bitumen 50/70+3% latex precursor to Sample 2.

TABLE 3
Latex powders in Bitumen 70/100 (BP)

| | Bitumen | Sample | Sample | Sample | Sample | Sample |
|---|---|---|---|---|---|---|
| Method | 70/100 | D | E | F | G | H |
| Softening Point | 45.6 | 48.5 | 51.6 | 54.8 | 50.8 | 50.3 |
| (° C.) | | | | | | |
| Needle penetration | 70 | 64 | 58 | 60 | 59 | 63 |
| at 25° C. (1/10 mm) | | | | | | |
| Viscosity at 135° C. | 571 | 822 | 1335 | 1664 | 1150 | 833 |
| (mPa · s)-Anton | | | | | | |
| Paar, 10 Hz | | | | | | |

Dynamic Shear Rheometer (DSR-OSC)

| | | | | | |
|---|---|---|---|---|---|
| Complex sheer | 30° C. | 288800 | 352700 | 326900 | 334900 |
| modulus G* (Pas) | 40° C. | 57700 | 75340 | 67830 | 70250 |
| | 50° C. | 11690 | 17800 | 15010 | 14810 |
| | 60° C. | 2853 | 4741 | 3884 | 3668 |
| | 70° C. | 820.5 | 1507 | 1218 | 1083 |
| | 80° C. | 278.5 | 558.1 | 441.3 | 384.3 |
| | 90° C. | 108.9 | 240.4 | 182.6 | 150.6 |
| Phase angle δ (°) | 30° C. | 72.4 | 69.4 | 70.7 | 68.3 |
| | 40° C. | 77.5 | 73.2 | 74.7 | 73.6 |
| | 50° C. | 82.0 | 77.3 | 78.9 | 79 |
| | 60° C. | 85.4 | 81.1 | 82.2 | 83.3 |
| | 70° C. | 87.7 | 83.6 | 84.6 | 86.4 |
| | 80° C. | 89.0 | 84.9 | 86.4 | 88.4 |
| | 90° C. | 89.7 | 84.8 | 87.5 | 89.3 |

Dynamic shear rheometer (DSR-MSCR)

| | | | | | | |
|---|---|---|---|---|---|---|
| Percent recovery | 0.1 kPa | 1.65 | 36.85 | 14.33 | 9.83 | 6.7 |
| (%) | 1.6 kPa | 1.2 | 13.9 | 7.39 | 3.69 | 1.94 |
| | 3.2 kPa | 0.35 | 7.04 | 4.13 | 1.46 | 0.54 |
| Non-recoverable | 0.1 kPa | 2.3 | 0.98 | 1.62 | 2.12 | 2.54 |
| compliance Jₙᵣ | 1.6 kPa | 2.38 | 1.48 | 1.85 | 2.42 | 2.77 |
| (1/kPa) | 3.2 kPa | 2.48 | 1.73 | 2.02 | 2.63 | 2.92 |
| Difference in | 0.1-1.6 kPa | 27.22 | 62.28 | 48.42 | 62.43 | 71.06 |
| percent recovery | 0.1-3.2 kPa | 78.85 | 80.88 | 71.19 | 85.11 | 91.96 |
| (%) | 1.6-3.2 kPa | 70.94 | 49.31 | 44.15 | 60.37 | 72.21 |
| Percent Difference | 0.1-1.6 kPa | 3.3 | 49.76 | 14.11 | 14.14 | 9 |
| in Jₙᵣ (%) | 0.1-3.2 kPa | 7.87 | 76 | 24.49 | 24.05 | 14.97 |
| | 1.6-3.2 kPa | 4.43 | 17.52 | 9.09 | 8.69 | 5.48 |

TABLE 4
Latex powders in Bitumen 50/70

| | Bitumen | | | | |
|---|---|---|---|---|---|
| Method | BP 50/70 | Sample H | Sample I | Sample J | Sample L |
| Softening Point (° C.) | 52.0 | 52.6 | 54.9 | 50.8 | Cannot be |
| Needle penetration | 53 | 46 | 51 | 49 | mixed |
| at 25° C. (1/10 mm) | | | | | properly, |
| Viscosity at 135° C. | 780 | 1170 | 1463 | 680 | sticky and |
| (Anton Paar), mPa · s | | | | | slimy gel. |

Dynamic Shear Rheometer (DSR-OSC)

| | | | | |
|---|---|---|---|---|
| Complex sheer | 30° C. | 363900 | 790500 | 587700 |
| modulus G* (Pas) | 40° C. | 77970 | 179800 | 108500 |
| | 50° C. | 16270 | 37720 | 19130 |
| | 60° C. | 3852 | 9587 | 4316 |
| | 70° C. | 1093 | 2881 | 1153 |
| | 80° C. | 360.6 | 1075 | 369.9 |
| | 90° C. | 136.6 | 510.3 | 141.8 |
| Phase angle δ (°) | 30° C. | 67.3 | 65.7 | 71.7 |
| | 40° C. | 72.6 | 70.4 | 78.1 |
| | 50° C. | 77.9 | 74.1 | 83.1 |
| | 60° C. | 82.5 | 76.4 | 86.2 |
| | 70° C. | 85.8 | 77.1 | 88.2 |
| | 80° C. | 88.0 | 74.2 | 89.4 |
| | 90° C. | 89.3 | 67.4 | 89.8 |

Dynamic shear rheometer (DSR-MSCR) @ 60° C., fresh

| | | | | | |
|---|---|---|---|---|---|
| Percent recovery | 0.1 kPa | 4.44 | 8.15 | 40.06 | −0.08 |
| (%) | 1.6 kPa | 2.38 | 3.89 | 21.65 | 0.19 |
| | 3.2 kPa | 0.89 | 2.1 | 12.75 | −0.29 |
| Non-recoverable | 0.1 kPa | 2.3 | 1.28 | 0.61 | 2.64 |
| compliance Jₙᵣ | 1.6 kPa | 2.44 | 1.36 | 0.83 | 2.67 |
| (1/kPa) | 3.2 kPa | 2.61 | 1.42 | 0.98 | 2.74 |
| Difference in | 0.1-1.6 kPa | 46.25 | 52.33 | 45.96 | 328.46 |
| percent recovery | 0.1-3.2 kPa | 79.88 | 74.19 | 68.16 | −246.02 |
| (%) | 1.6-3.2 kPa | 62.57 | 45.86 | 41.08 | 251.46 |
| Percent Difference | 0.1-1.6 kPa | 6.4 | 5.93 | 36.8 | 1.17 |
| in Jₙᵣ (%) | 0.1-3.2 kPa | 13.68 | 10.42 | 61.57 | 3.66 |
| | 1.6-3.2 kPa | 6.85 | 4.23 | 18.1 | 2.46 |

### Example 3: Carboxylated SB Latex Powders in Bitumen 50/70

Samples: A carboxylated SB latex having a Tg of −25° C. was dried to powders and examined in bitumen grade 50/70 from BP according to German standard characterization.

Sample M: Bitumen 50/70+3% by weight carboxylated SB liquid dispersion having a solid content of 52.11 wt % and a Tg of −25° C., based on the weight of bitumen.

Sample N: Bitumen 50/70+3% by weight dispersion powder comprising a carboxylated SB latex having a Tg of −25° C. spray dried with Maltodextrin M100, based on the weight of bitumen.

Sample 0: Bitumen 50/70+3% by weight dispersion powder comprising carboxylated SB latex having a Tg of −25° C. spray dried with Mowiol 4-88, based on the weight of bitumen.

Sample P: Bitumen 50/70+3% by weight dispersion powder comprising a carboxylated SB latex having a Tg of −25° C. spray dried with Luvitec K30, based on the weight of bitumen.

Sample Q: (control): Bitumen 50/70+3% by weight dispersion powder re-dispersed to original solid content (52.11 wt %) of carboxylated SB latex having a Tg of −25° C., based on the weight of bitumen.

Sample R: (control): Bitumen 50/70+3% by weight dispersion powder re-dispersed to original solid content (52.11 wt %) of carboxylated SB latex having a Tg of −25° C., based on the weight of bitumen.

Sample S: (control): Bitumen 50/70+3% by weight dispersion powder re-dispersed to original solid content (52.11 wt %) of carboxylated SB latex having a Tg of −25° C., based on the weight of bitumen.

Sample T (control): Bitumen 50/70+0.45% Maltodextrin M100 (corresponds to amount that was added in sample N).

Sample U (control): Bitumen 50/70+0.45% Mowiol 4-88 (corresponds to amount that was added in sample 0).

Sample V (control): Bitumen 50/70+0.45% Luvitec K30 (corresponds to the amount that was added in sample P).

TABLE 5
Latex powders in Bitumen 50/70

| | Bitumen | Sample | Sample | Sample | Sample | Sample |
|---|---|---|---|---|---|---|
| Method | 50/70 | M | N | O | P | Q |
| Softening Point, ° C. | 49.4 | 56 | 56.4 | 53.2 | 54.9 | 54.7 |
| Needle penetration | 54.7 | 41.3 | 30.1 | 48.7 | 35 | 37.2 |
| at 25° C. (1/10 mm) | | | | | | |
| Viscosity at 135° C. | 538.16 | 1597.4 | 1039.4 | 2435.1 | 1009.8 | 1213.4 |
| (mPa · s)-Anton | | | | | | |
| Paar, 10 Hz | | | | | | |

Dynamic Shear Rheometer (DSR-OSC)

| | | | | | | | |
|---|---|---|---|---|---|---|---|
| Complex sheer | 30° C. | 898010 | 773140 | 1455300 | 1033600 | 1034000 | 959230 |
| modulus G* (Pas) | 40° C. | 150310 | 141810 | 283000 | 194600 | 200160 | 182080 |
| | 50° C. | 26816 | 28313 | 55884 | 38624 | 38736 | 37132 |
| | 60° C. | 5712 | 7055.5 | 12432 | 8942.9 | 8602.4 | 8731.7 |
| | 70° C. | 1463.5 | 2158 | 3156.4 | 2385.6 | 2261.1 | 2318.6 |
| | 80° C. | 446.83 | 709.55 | 944.17 | 741.1 | 705.39 | 732.29 |
| | 90° C. | 160.31 | 251.06 | 324.14 | 250.81 | 250.27 | 259.88 |
| Phase angle δ (°) | 30° C. | 68.73 | 66.36 | 59.98 | 63.9 | 62.97 | 64.55 |
| | 40° C. | 76.12 | 72.11 | 68.36 | 70.2 | 71.01 | 70.1 |
| | 50° C. | 81.34 | 75.38 | 75.34 | 75.38 | 77.9 | 75.5 |
| | 60° C. | 85.12 | 76.91 | 80.96 | 79.51 | 82.86 | 80.94 |
| | 70° C. | 87.58 | 79.64 | 85 | 82.94 | 86.07 | 85.11 |
| | 80° C. | 89.14 | 83.65 | 87.69 | 85.9 | 88.08 | 87.35 |
| | 90° C. | 89.94 | 86.64 | 89.2 | 88.33 | 89.26 | 88.9 |

Dynamic shear rheometer (DSR-MSCR)

| | | | | | | | |
|---|---|---|---|---|---|---|---|
| Percent recovery | 0.1 kPa | 0.48 | 34.61 | 6.7 | 14.1 | 5.9 | 10.89 |
| (%) | 1.6 kPa | −0.24 | 11.55 | 4.45 | 4.61 | 3.15 | 4.75 |
| | 3.2 kPa | −0.88 | 5.23 | 2.45 | 1.91 | 1.51 | 2.12 |
| Non-recoverable | 0.1 kPa | 2.83 | 0.82 | 0.82 | 1.19 | 1.08 | 1.05 |
| compliance Jₙᵣ | 1.6 kPa | 2.94 | 1.27 | 0.86 | 1.4 | 1.14 | 1.17 |
| (1/kPa) | 3.2 kPa | 3.06 | 1.49 | 0.9 | 1.53 | 1.2 | 1.27 |
| Difference in | 0.1-1.6 kPa | 149.91 | 66.63 | 33.61 | 67.28 | 46.59 | 56.36 |
| percent recovery | 0.1-3.2 kPa | 281.34 | 84.9 | 63.49 | 86.49 | 74.33 | 80.52 |
| (%) | 1.6-3.2 kPa | −263.32 | 54.79 | 45.01 | 58.71 | 51.94 | 55.35 |
| Percent Difference | 0.1-1.6 kPa | 3.86 | 55.31 | 4.25 | 17.27 | 5.52 | 11.79 |
| in Jₙᵣ (%) | 0.1-3.2 kPa | 7.94 | 81.79 | 9.2 | 28.37 | 11.03 | 21 |
| | 1.6-3.2 kPa | 3.93 | 17.05 | 4.75 | 9.46 | 5.22 | 8.24 |

TABLE 6
Latex powders in Bitumen 50/70

| | Bitumen | Sample | Sample | Sample | Sample | Sample |
|---|---|---|---|---|---|---|
| Method | 50/70 | R | S | T | U | V |
| Softening Point, ° C. | 49.4 | 53 | 55.4 | 50.9 | 52.7 | 50.6 |
| Needle penetration | 54.7 | 40.4 | 36.7 | 46.8 | 36.6 | 47.3 |
| at 25° C. (1/10 mm) | | | | | | |
| Viscosity at 135° C. | 538.16 | 1195.5 | 1740.7 | 587.94 | 694.53 | 589.34 |
| (mPa · s)-Anton | | | | | | |
| Paar, 10 Hz | | | | | | |

Dynamic Shear Rheometer (DSR-OSC)

| | | | | | | | |
|---|---|---|---|---|---|---|---|
| Complex sheer | 30° C. | 898010 | 891280 | 921460 | 789840 | 912860 | 753320 |
| modulus G* (Pas) | 40° C. | 150310 | 168100 | 185610 | 131370 | 157230 | 125710 |
| | 50° C. | 26816 | 33312 | 41122 | 23454 | 28575 | 22504 |
| | 60° C. | 5712 | 7488.9 | 10793 | 5083.2 | 6259.3 | 4813.6 |
| | 70° C. | 1463.5 | 1962.6 | 3184.1 | 1330.5 | 1625.2 | 1283.5 |
| | 80° C. | 446.83 | 617.52 | 1013.9 | 410 | 497.18 | 396.96 |
| | 90° C. | 160.31 | 219.9 | 275.56 | 146.57 | 176.66 | 143.57 |
| Phase angle δ (°) | 30° C. | 68.73 | 64.92 | 62.76 | 69.19 | 67.34 | 69.88 |
| | 40° C. | 76.12 | 71.47 | 66.76 | 76.26 | 74.82 | 76.7 |
| | 50° C. | 81.34 | 77.59 | 69.08 | 81.48 | 80.33 | 81.83 |
| | 60° C. | 85.12 | 82.92 | 70.39 | 85.22 | 84.44 | 85.45 |
| | 70° C. | 87.58 | 86.34 | 76.32 | 87.64 | 87.16 | 87.75 |
| | 80° C. | 89.14 | 88.33 | 83.27 | 89.2 | 88.92 | 89.28 |
| | 90° C. | 89.94 | 89.41 | 87.85 | 89.86 | 89.58 | 89.96 |

Dynamic shear rheometer (DSR-MSCR)

| | | | | | | | |
|---|---|---|---|---|---|---|---|
| Percent recovery | 0.1 kPa | 0.48 | 12.96 | 92.64 | 2.8 | 2.94 | 1.12 |
| (%) | 1.6 kPa | −0.24 | 3.52 | 15.22 | 0.44 | 1.28 | 0.15 |
| | 3.2 kPa | −0.88 | 1.37 | 6.62 | -0.5 | 0.38 | 0.44 |
| Non-recoverable | 0.1 kPa | 2.83 | 1.08 | 0.03 | 2.27 | 1.59 | 2.23 |
| compliance Jₙᵣ | 1.6 kPa | 2.94 | 1.32 | 0.72 | 2.41 | 1.66 | 2.31 |
| (1/kPa) | 3.2 kPa | 3.06 | 1.46 | 0.95 | 2.56 | 1.73 | 2.4 |
| Difference in | 0.1-1.6 kPa | 149.91 | 72.85 | 83.57 | 84.11 | 55.09 | 86.63 |
| percent recovery | 0.1-3.2 kPa | 281.34 | 89.41 | 92.85 | 117.78 | 86.7 | 139.51 |
| (%) | 1.6-3.2 kPa | −263.32 | 61.01 | 56.51 | 211.91 | 70.38 | 395.55 |
| Percent Difference | 0.1-1.6 kPa | 3.86 | 22.15 | 1974.01 | 6.31 | 4.2 | 3.78 |
| in Jₙᵣ (%) | 0.1-3.2 kPa | 7.94 | 34.46 | 2656.03 | 12.53 | 5.68 | 7.95 |
| | 1.6-3.2 kPa | 3.93 | 10.07 | 32.88 | 5.85 | 4.3 | 3.93 |

The softening points for the polymer modified bitumen were higher than for the unmodified bitumen. Re-dissolution of the powder dispersions back to liquid dispersions did not provide significantly different results compared to the dried powders. As a control, the pure drying aids were tested and have no or little influence on the softening points. Similar trends were observed for the needle penetration, with lower needle penetration values for all polymer modified bitumen.

The viscosity at 135° C. were also measured for all samples by DSR, with higher viscosities observed for the polymer modified bitumen compared to bitumen only or bitumen comprising drying aid only. Surprisingly, the viscosity for samples O and S were higher than for sample M. Sample S reached values similar to the elastic recovery (MSCR) of the polymer modified bitumen obtained by adding the liquid dispersion (sample M), though as an overall trend an effect on the elastic recovery could be seen for compositions comprising the dispersion powders (samples N to S) but not for the compositions with spray drying aids only (samples T, U and V).

By looking at the G* values at different temperatures, it can be seen that the polymer modified bitumen exhibited higher complex sheer moduli then the unmodified bitumen with most of the samples having values similar to the bitumen that was modified with the liquid dispersion (sample M). Samples N (maltodextrin) and S (luvitec re-dispersed) had G* values higher then sample M. No noticeable impact of the pure spray drying aids (samples T, U and V) on the complex sheer moduli was noted. Similar observations were made when looking at the phase angle values at different temperatures, with the polymer modified bitumen being more elastic then the unmodified bitumen, especially at lower temperatures. The impact of the samples N (Maltodextrin M100) and S (Luvitec K30) were higher than for the bitumen that was modified with the liquid dispersion (sample M).

Overall, spray-drying of the carboxylated SB latex having a Tg of −25° C. resulted in dried powders that are capable of modifying bitumen.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

1.-36. (canceled)

37. A dispersible copolymer powder comprising:
a) a core polymer derived from a vinyl aromatic monomer, a 1,3-diene monomer, and optionally one or more ethylenically-unsaturated monomers selected from the group consisting of meth(acrylate) monomers, vinyl acetate monomers, vinyl ester monomers, acid monomers, and combinations thereof, wherein the core polymer has a glass transition temperature (T_{g}) of 40° C. or less; and
b) a shell comprising a water soluble protective colloid polymer, wherein the protective colloid polymer has a glass transition temperature (T_{g}) of 50° C. or greater.

38. The dispersible copolymer powder of claim 37, wherein the core polymer is a random polymer.

39. The dispersible copolymer powder of claim 37, wherein the core polymer comprises a styrene-butadiene copolymer.

40. The dispersible copolymer powder of claim 37, wherein the core polymer comprises styrene and butadiene in a weight ratio of styrene to butadiene of from 5:95 to 80:20 or from 5:95 to 30:70.

41. The dispersible copolymer powder of claim 37, wherein the core polymer comprises from 0.5% to 25% by weight of a carboxylic acid monomer.

42. The dispersible copolymer powder of claim 41, wherein the carboxylic acid monomer is selected from itaconic acid, fumaric acid, acrylic acid, methacrylic acid, and combinations thereof.

43. The dispersible copolymer powder of claim 37, wherein the core polymer has a glass transition temperature of 25° C. or less, preferably from −90° C. to 25° C.

44. The dispersible copolymer powder of claim 37, wherein the core polymer and the protective colloid polymer are present in a weight ratio of from 2:1 to 20:1.

45. The dispersible copolymer powder of claim 37, wherein the protective colloid polymer comprises a polyvinyl alcohol, a polyvinyl pyrrolidone, a polysaccharide, or a combination thereof.

46. The dispersible copolymer powder of claim 37, wherein the protective colloid polymer comprises a polysaccharide, wherein the polysaccharide includes maltodextrin, hydroxyethyl cellulose, or a combination thereof.

47. The dispersible copolymer powder of claim 37, wherein the protective colloid polymer has a molecular weight of 100,000 Da or less.

48. The dispersible copolymer powder of claim 37, wherein the protective colloid polymer has a glass transition temperature of from 50° C. to 200° C., or from 60° C. to 180° C.

49. An asphalt composition comprising:
a) asphalt,
b) a dispersible copolymer powder derived from
i) a core polymer derived from a vinyl aromatic monomer, a 1,3-diene monomer, and optionally one or more ethylenically-unsaturated monomers selected from the group consisting of meth(acrylate) monomers, vinyl acetate monomers, vinyl ester monomers, acid monomers, and combinations thereof, wherein the core polymer has a glass transition temperature (T_{g}) of 40° C. or less; and
ii) a shell comprising a water soluble protective colloid polymer, wherein the protective colloid polymer has a glass transition temperature (T_{g}) of 50° C. or greater.

50. The asphalt composition of claim 53, wherein the fresh SHRP high temperature is 70° C. or greater, and/or the RTFO SHRP high temperature is 76° C. or greater, for asphalt compositions comprising at least 3% by weight or greater of the dispersible copolymer powder.

51. The asphalt composition of claim 53, wherein the asphalt composition has a Brookfield viscosity at 135° C. of less than 2,000 cP.

52. The asphalt composition of claim 53, wherein the asphalt is present in an amount of from 50% to 99.9% by weight, from 50% to 98% by weight, or from 50% to 85% by weight, based on the weight of the asphalt composition.

53. The asphalt composition of claim 53, wherein the core polymer is a random polymer.

54. The asphalt composition of claim 53, wherein the core polymer comprises a styrene-butadiene copolymer.

55. The asphalt composition of claim 53, wherein the core polymer comprises styrene and butadiene in a weight ratio of styrene to butadiene of from 5:95 to 80:20 or from 5:95 to 30:70.

56. The asphalt composition of claim 53, wherein the core polymer further comprises from 0.5% to 25%, preferably from 0.5% to 10% by weight of a carboxylic acid monomer.

57. The asphalt composition of claim 60, wherein the carboxylic acid monomer is selected from itaconic acid, fumaric acid, acrylic acid, methacrylic acid, and combinations thereof.
